(19) United States
(12) Patent Application Publication
(10) Pub. No.: US 2026/0369203 A1
(43) Pub. Date: Nov. 19, 2026

(54) VOLTAGE ADJUSTMENT CIRCUIT, DISPLAY PANEL AND DRIVING METHOD THEREOF

(71) Applicant: Beijing Visionox Technology Co., Ltd., Beijing (CN)

(72) Inventor: Hongjun XIE, Beijing (CN)

(73) Assignee: Beijing Visionox Technology Co., Ltd., Beijing (CN)

(21) Appl. No.: 19/726,764

(22) Filed: Jun. 30, 2026

(30) Foreign Application Priority Data
Dec. 24, 2025 (CN) 202511971966.4

(51) Int. Cl. G09G 3/20

(52) U.S. Cl. CPC G09G 3/2007; G09G 2310/08

(57) ABSTRACT

The embodiment of the present disclosure discloses a voltage regulation circuit, a display panel, and a driving method thereof. An initialization module transmits an initialization voltage to a signal line in a first phase, and a voltage regulation module regulates the voltage on the signal line in a second phase. By adjusting the conduction current or conduction time of the voltage regulation module, the speed or time of charging or discharging the signal line is adjusted, and after the second phase, different voltages can be present on the signal line. When the voltage regulation circuit is applied to a display device, the voltage on the data line is regulated by the voltage regulation module, and after the second phase, under different display gray levels, the data voltage to which the data line is charged or discharged differs.

### CROSS REFERENCE TO RELATED APPLICATION

The present application claims priority to Chinese Patent Application No. 202511971966.4, filed on Dec. 24, 2024, which is incorporated herein by reference in its entirety.

### FIELD

The present disclosure relates to the field of display technology, and in particular, to a voltage adjustment circuit, a display panel and a driving method thereof, and a display device.

### BACKGROUND

With the development of display technology, the colors of display devices are becoming increasingly rich.

In the related art, a display device is usually provided with a driving chip, which provides a data voltage to a pixel circuit to achieve display of different gray scales. How to achieve multi-gray scale display without providing a driving chip has become an urgent problem to be solved.

### SUMMARY

The present disclosure provides a voltage adjustment circuit, a display panel and a driving method thereof, and a display device, to achieve multi-gray scale display of a display device without providing a driving chip.

According to one aspect of the present disclosure, there is provided a voltage adjustment circuit, including: an initialization module and a voltage adjustment module; the initialization module is used for connecting to a signal line and for transmitting an initialization voltage to the signal line in a first phase; the voltage adjustment module is used for connecting to the signal line and for adjusting a voltage on the signal line in a second phase; the second phase is performed after the first phase.

According to one aspect of the present disclosure, there is provided another voltage adjustment circuit, including a voltage adjustment module, the voltage adjustment module including at least two voltage adjustment branches connected in parallel; one end of the voltage adjustment branch is used for connecting to a signal line, and the other end is connected to a first fixed voltage terminal, the voltage adjustment branch being used for adjusting a voltage on the signal line.

According to another aspect of the present disclosure, there is provided a display panel, including a plurality of voltage adjustment circuits according to any embodiment of the present disclosure, and the signal lines include data lines.

According to another aspect of the present disclosure, a driving method for driving a display panel is provided. The display panel includes a plurality of voltage adjustment circuits according to any embodiment of the present disclosure, and the signal lines include data lines. The driving method includes: dividing into a plurality of driving phases to write data voltages to a plurality of pixel circuits. In the driving phase, writing the data voltage to a portion of the pixel circuits. each driving phase comprises a first phase, a second phase, and a data writing phase. In the first phase, controlling the initialization module in each voltage adjustment circuit to be turned on to transmit an initialization voltage to the data line. In the second phase, adjusting the voltage on the data line by controlling the conduction state of the voltage adjustment branch of the voltage adjustment module in each voltage adjustment circuit. The second phase is performed after the first phase. In the data writing phase, controlling the data writing module of a portion of the pixel circuits to be turned on to write the data voltage to the driving module of the portion of the pixel circuits.

According to another aspect of the present disclosure, there is provided a display device, including the display panel according to any embodiment of the present disclosure.

The voltage regulation circuit, display panel, driving method thereof, and display device according to embodiments of the present disclosure transmit an initialization voltage to a signal line via an initialization module in a first phase, regulate the voltage on the signal line via a voltage regulation module in a second phase, and adjust the speed or time of charging or discharging the signal line by adjusting the conduction current or conduction time of the voltage regulation module, and after the second phase, the signal line can have different voltages. When the voltage regulation circuit is applied to a display device, by regulating the voltage on a data line via the voltage regulation module, after the second phase, the data voltage to which the data line is charged or discharged differs under different display gray levels. Thus, under different display gray levels, the data voltage written to the control terminal of a driving module of a pixel circuit differs, causing the current generated by the driving module to differ, thereby achieving different light emission brightness of a light-emitting module connected to the pixel circuit, enabling display of different gray levels.

Furthermore, by including the voltage regulation circuit in the display panel, multi-gray-level display can be achieved without the need for a driving chip, meeting the requirements of space-constrained display devices or flexible display devices. The content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

To more clearly illustrate the embodiments of the present disclosure, the drawings required for describing the embodiments are briefly introduced below. In one embodiment, the drawings in the following description are only some embodiments of the present disclosure.

FIG. 1 is a schematic structural diagram of a voltage regulation circuit provided by an embodiment of the present disclosure;

FIG. 2 is a schematic structural diagram of a pixel circuit in the related art;

FIG. 3 is a schematic structural diagram of another pixel circuit in the related art;

FIG. 4 is a schematic structural diagram of another voltage regulation circuit provided by an embodiment of the present disclosure;

FIG. 5 is a schematic structural diagram of yet another voltage regulation circuit provided by an embodiment of the present disclosure;

FIG. 6 is a schematic structural diagram of yet another voltage regulation circuit provided by an embodiment of the present disclosure;

FIG. 7 is a schematic diagram of an output characteristic curve of a transistor provided by an embodiment of the present disclosure;

FIG. 8 is a schematic structural diagram of yet another voltage regulation circuit provided by an embodiment of the present disclosure;

FIG. 9 is a schematic structural diagram of yet another voltage regulation circuit provided by an embodiment of the present disclosure;

FIG. 10 is a schematic structural diagram of yet another voltage regulation circuit provided by an embodiment of the present disclosure;

FIG. 11 is a schematic structural diagram of another voltage regulation circuit provided by an embodiment of the present disclosure;

FIG. 12 is a schematic structural diagram of a level shifting unit provided by an embodiment of the present disclosure;

FIG. 13 is a specific circuit diagram of a level shifting unit;

FIG. 14 is a schematic structural diagram of another voltage regulation circuit provided by an embodiment of the present disclosure;

FIG. 15 is a schematic structural diagram of yet another voltage regulation circuit provided by an embodiment of the present disclosure;

FIG. 16 is a schematic structural diagram of another voltage regulation circuit provided by an embodiment of the present disclosure;

FIG. 17 is a schematic structural diagram of a display panel provided by an embodiment of the present disclosure;

FIG. 18 is a schematic structural diagram of another display panel provided by an embodiment of the present disclosure;

FIG. 19 is a flowchart of a driving method of a display panel provided by an embodiment of the present disclosure;

FIG. 20 is a driving timing diagram of a display panel provided by an embodiment of the present disclosure;

FIG. 21 is a driving timing diagram of another display panel provided by an embodiment of the present disclosure;

FIG. 22 is a schematic structural diagram of yet another display panel provided by an embodiment of the present disclosure;

FIG. 23 is a driving timing diagram of a display panel provided by an embodiment of the present disclosure;

FIG. 24 is a schematic structural diagram of a display device provided by an embodiment of the present disclosure.

### DETAILED DESCRIPTION

To enable those to better understand the solutions of the present disclosure, the embodiments of the present disclosure will be clearly and completely described below in conjunction with the drawings in the embodiments of the present disclosure. In one embodiment, the described embodiments are only a part of the embodiments of the present disclosure, not all of them.

The terms “first”, “second”, etc. in the specification and claims of the present disclosure and the above drawings are used to distinguish similar objects, and are not necessarily used to describe a specific order or sequence. The data used in one embodiment, can be interchanged under appropriate circumstances, and the embodiments of the present disclosure described herein can be implemented in an order other than those illustrated or described herein. Furthermore, the terms “include” and “have” and any variations thereof are intended to cover non-exclusive inclusion, for example, a process, method, system, product, or device that includes a series of steps or units is not necessarily limited to those steps or units explicitly listed, but may include other steps or units not explicitly listed or inherent to such process, method, product, or device.

How to achieve multi-gray-level display without providing a driving chip has become an urgent problem to be solved. In one embodiment, since a driving chip occupies an amount of space, it cannot be used in space-constrained display devices (e.g., augmented reality products). Additionally, driving chips are typically silicon-based chips with poor flexibility, and the use of a driving chip can affect the flexibility of the display device. Therefore, there is an urgent need for a display device that does not use a driving chip to achieve multi-gray-level display, to meet the requirements of space-constrained display devices or flexible display devices.

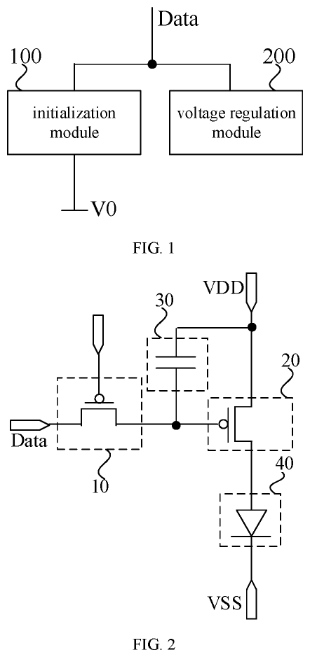

An embodiment of the present disclosure provides a voltage regulation circuit. FIG. 1 is a schematic structural diagram of a voltage regulation circuit provided by an embodiment of the present disclosure. Referring to FIG. 1, the voltage regulation circuit includes an initialization module 100 and a voltage regulation module 200. The initialization module 100 is configured to be connected to a signal line and to transmit an initialization voltage V0 to the signal line in a first phase. The voltage regulation module 200 is configured to be connected to the signal line and to regulate the voltage on the signal line in a second phase; the second phase is performed after the first phase.

In an embodiment, the voltage regulation circuit is applied in a display device. As shown in FIG. 1, the signal line may be a data line Data of the display device. In other optional embodiments of the present disclosure, the voltage regulation circuit may also be applied in other electronic circuits, which is not particularly limited in the embodiments of the present disclosure.

The initialization module 100 may include circuit devices having a switching function. In a first phase, the initialization module 100 is turned on to transmit an initialization voltage to the signal line. The voltage regulation module 200 may also include devices having a switching function, and the voltage regulation module 200 is connected to the signal line. In a second phase, the voltage regulation module 200 regulates the voltage on the signal line. The manner of regulating the voltage on the signal line may include charging or discharging. In the case of charging, the voltage on the signal line gradually increases from the initialization voltage until the end of the second phase. In the case of discharging, the voltage on the signal line gradually decreases from the initialization voltage until the end of the second phase.

In some embodiments, the charging current is regulated by the voltage regulation module 200 to adjust the charging speed, thereby regulating the voltage on the signal line after the end of the second phase. In other embodiments, the discharging current is regulated by the voltage regulation module 200 to adjust the discharging speed, thereby regulating the voltage on the signal line after the end of the second phase. In yet other embodiments, the voltage on the signal line after the end of the second phase may also be regulated by adjusting the duration of the second phase, thereby adjusting the total time for charging or discharging.

When the voltage regulation circuit is applied in a display device, the voltage regulation circuit may be configured to charge or discharge the data line Data with a corresponding total current in the second phase according to a data signal. The total current for charging or discharging corresponding to the voltage regulation module 200 differs under data signals corresponding to different display gray levels, and after the second phase, the data voltages on the data line Data are different. In an embodiment, the data signal includes an image data signal.

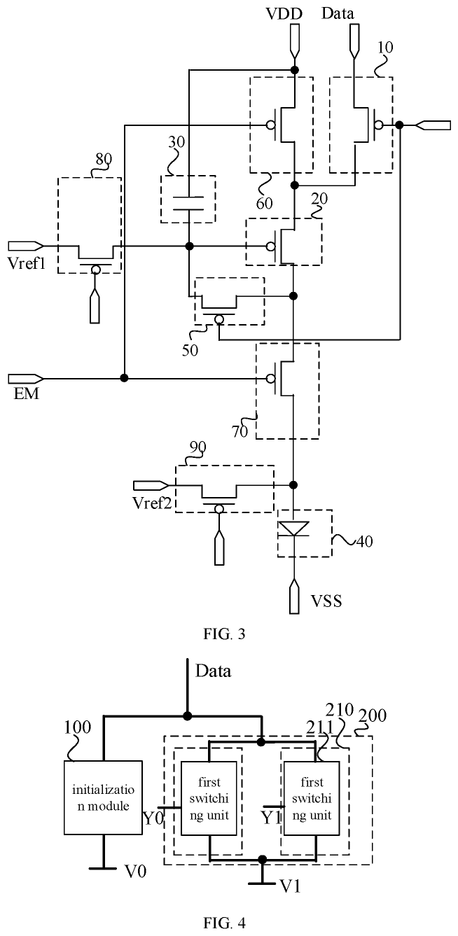

The display device includes a plurality of data lines Data and a plurality of pixel circuits. The data lines Data are electrically connected to the plurality of pixel circuits for transmitting data voltages to the pixel circuits. FIG. 2 is a schematic structural diagram of a pixel circuit in the related art. FIG. 3 is a schematic structural diagram of another pixel circuit in the related art. Referring to FIG. 2, the pixel circuit includes a data writing module 10, a driving module 20, and a storage module 30. A first terminal of the data writing module 10 is connected to the data line Data, and a second terminal of the data writing module 10 is connected to a control terminal of the driving module 20. The storage module 30 is connected to the control terminal of the driving module 20. A first terminal of the driving module 20 is connected to a first power line VDD, and a second terminal of the driving module 20 is connected to a first terminal of a light-emitting module 40. A second terminal of the light-emitting module 40 is connected to a second power line VSS. The storage module 30 is also connected to the first power line VDD.

Referring to FIG. 3, the pixel circuit includes a data writing module 10, a driving module 20, a compensation module 50, a first light-emitting control module 60, a second light-emitting control module 70, a first reset module 80, a second reset module 90, and a storage module 30. A first terminal of the data writing module 10 is connected to the data line Data, and a second terminal of the data writing module 10 is connected to a first terminal of the driving module 20. The compensation module 50 is connected between a control terminal and a second terminal of the driving module 20. The first light-emitting control module 60 is connected between the first power line VDD and the first terminal of the driving module 20. The second light-emitting control module 70 is connected between the second terminal of the driving module 20 and the first terminal of the light-emitting module 40. The second terminal of the light-emitting module 40 is connected to the second power line VSS. One terminal of the first reset module 80 is connected to a first reset signal line Vref1, and the other terminal is connected to the control terminal of the driving module 20. One terminal of the second reset module 90 is connected to a second reset signal line Vref2, and the other terminal is connected to the first terminal of the light-emitting module 40. Two terminals of the storage module 30 are respectively connected to the control terminal of the driving module 20 and the first power line VDD.

The operation process of the pixel circuit includes a data writing phase. For the pixel circuit shown in FIG. 2, in the data writing phase, the data writing module 10 is turned on to transmit the data voltage on the data line Data to the control terminal of the driving module 20. For the pixel circuit shown in FIG. 3, in the data writing phase, the data writing module 10 and the compensation module 50 are turned on, and the data voltage on the data line Data is transmitted to the control terminal of the driving module 20 through the data writing module 10, the driving module 20, and the compensation module 50.

In the embodiment of the present disclosure, one terminal of the initialization module 100 is connected to an initialization voltage V0, and the other terminal is connected to the data line Data. In the first phase, the initialization module 100 is turned on to transmit the initialization voltage V0 to the data line Data, and the voltage on the data line Data equals the initialization voltage V0. The voltage regulation module 200 is also connected to the data line Data. In the second phase, the data line Data is charged or discharged with a total current corresponding to the data signal. The second phase is performed after the first phase. Thus, when the data line Data is charged in the second phase, the voltage on the data line Data gradually increases from the initialization voltage V0; when the data line Data is discharged in the second phase, the voltage on the data line Data gradually decreases from the initialization voltage V0. The voltage regulation module 200 at least includes devices having a switching function. Under data signals corresponding to at least part of the display gray levels, in the second phase, the voltage regulation module 200 is turned on, thereby charging or discharging the data line Data with the total current corresponding to the data signal.

The data signal corresponds to a display grayscale, and different display grayscales correspond to different data signals. The duration of the second phase is limited. In some embodiments, the duration of the second phase is fixed. By charging or discharging the data line Data with a total current corresponding to the data signal within the limited time of the second phase, the total current for charging or discharging by the voltage regulation module 200 varies under data signals corresponding to different display grayscales. Consequently, after the second phase, the data line Data is charged or discharged to different voltages under data signals corresponding to different display grayscales. After the second phase, the voltage to which the data line Data is charged or discharged serves as the data voltage. The voltage regulation module 200, based on the data signal, charges or discharges the data line Data with the corresponding total current during the second phase, and after the second phase, the data voltage on the data line Data differs under data signals corresponding to different display grayscales. As a result, the data voltage written to the control terminal of the driving module of the pixel circuit during the data writing phase differs, and the driving current generated by the driving module is related to the data voltage. Thus, under data signals corresponding to different display grayscales, the driving current generated by the driving module varies. Since the light-emitting module driven by the pixel circuit is related to the driving current, the brightness of the light-emitting module differs under different driving currents, thereby enabling display of different grayscales.

The voltage regulation circuit is an internal structure of the display panel, rather than a driving chip external to the display panel; that is, the display panel includes the voltage regulation circuit. In the voltage regulation circuit, the circuit devices of the initialization module 100 and the voltage regulation module 200 can be simultaneously fabricated in the same process as other circuit devices in the display device, for example, fabricated in the same process as the circuit devices of the pixel circuit. This allows the voltage regulation circuit to be co-fabricated with the pixel circuit and/or other circuits in the display device (e.g., a gate driving circuit), enabling multi-grayscale display of the display device without requiring a driving chip in the display device.

In the voltage regulation circuit of an embodiment of the present disclosure, the initialization module transmits an initialization voltage to the signal line during the first phase, and the voltage regulation module adjusts the voltage on the signal line during the second phase. By adjusting the conduction current or conduction time of the voltage regulation module, the speed or duration of charging or discharging the signal line is regulated, and after the second phase, different voltages can be present on the signal line. When the voltage regulation circuit is applied to a display device, the voltage on the data line is adjusted by the voltage regulation module, and after the second phase, the data voltage to which the data line is charged or discharged differs under different display grayscales. Consequently, under different display grayscales, the data voltage written to the control terminal of the driving module of the pixel circuit differs, resulting in different currents generated by the driving module. This leads to different light emission brightness of the light-emitting module connected to the pixel circuit, thereby enabling display of different grayscales. By providing the voltage regulation circuit in the display panel, multi-grayscale display can be achieved without a driving chip, meeting the requirements of space-constrained display devices or flexible display devices.

FIG. 4 is a schematic structural diagram of another voltage regulation circuit provided by an embodiment of the present disclosure. Referring to FIG. 4, in an embodiment, the voltage regulation module 200 includes at least two voltage regulation branches 210 connected in parallel. The voltage regulation branch 210 at least includes a first switching unit 211. The voltage regulation branch 210 is connected between the signal line (FIG. 4 illustrates the case where the signal line is the data line Data) and a first fixed voltage terminal V1, and is configured to be turned on or off based on the data signal. At least two voltage regulation branches 210 have different conduction currents when the at least two voltage regulation branches 210 are turned on. In an embodiment, the voltage regulation branches 210 are connected in parallel.

The first fixed voltage terminal V1 receives a first fixed voltage, and the magnitude of the first fixed voltage remains constant. The voltage regulation branch 210 at least includes a first switching unit 211. When the first switching unit 211 is turned on, the voltage regulation branch 210 connects the data line Data (the data line is marked as “Data”) and the first fixed voltage terminal V1. In a case where the first fixed voltage is greater than the initialization voltage V0, when the voltage regulation branch 210 is turned on, it can charge the data line Data, causing the voltage on the data line Data to rise. In a case where the first fixed voltage is less than the initialization voltage V0, when the voltage regulation branch 210 is turned on, it can discharge the data line Data, causing the voltage on the data line Data to drop. The voltage regulation branch 210 can be turned on or off based on the data signal, and at least two voltage regulation branches 210 have different conduction currents when the at least two voltage regulation branches 210 are turned on.

In an embodiment, under data signals corresponding to different display grayscales, the turned-on voltage regulation branches 210 are not completely identical. Thus, under data signals corresponding to different display grayscales, the total current for charging or discharging the data line Data by the voltage regulation module 200 during the second phase differs in magnitude. In an embodiment, the durations of the effective level voltages controlling the voltage regulation branches 210 corresponding to the data signals are the same. The effective level voltage is the voltage that controls the turning on of the voltage regulation branch 210. Therefore, the voltage regulation branches 210 corresponding to different conduction currents have the same conduction duration during the second phase. Consequently, when different voltage regulation branches 210 are turned on, after the second phase, the total voltage to which the data line Data is charged or discharged from the initialization voltage differs, resulting in different data voltage magnitudes on the data line Data. In one embodiment, under data signals corresponding to different display grayscales, the driving current output by the pixel circuit differs in magnitude, thereby enabling display of different grayscales.

Among them, under data signals corresponding to some display grayscales, each voltage regulation branch 210 may be non-conductive, so in the second phase, the data line Data is not charged or discharged. Under data signals corresponding to other display grayscales, at least one voltage regulation branch 210 may be conductive to charge or discharge the data line Data in the second phase. In an embodiment, under data signals corresponding to different display grayscales, the conductive voltage regulation branches 210 are different (including cases where the numbers of conductive voltage regulation branches 210 are the same but the charge/discharge currents of the conductive voltage regulation branches 210 are different, and cases where the number of conductive voltage regulation branches 210 is different), thereby achieving different degrees of charging or discharging of the data line Data under data signals corresponding to different display grayscales, resulting in different data voltages on the data line Data after the second phase.

FIG. 5 is a schematic structural diagram of another voltage regulation circuit provided by an embodiment of the present disclosure. Referring to FIG. 5, in an embodiment, in this voltage regulation circuit, the voltage regulation module 200 further includes a regulation control unit 220, which is connected between the voltage regulation branch 210 and the signal line (FIG. 5 shows the signal line as the data line Data), and is used to be conductive in the second phase and turned off in the first phase. In an embodiment, the control terminal of the initialization module 100 is connected to the first control signal line SW1, and the control terminal of the regulation control unit 220 is connected to the second control signal line SW2.

The regulation control unit 220 includes a device with a switching function. In an embodiment, the regulation control unit 220 includes a second switch unit. In the first phase, the regulation control unit 220 is turned off, and the data line Data is disconnected from the voltage regulation branch 210, preventing the voltage on the data line Data from being affected by the voltage regulation branch 210 in the first phase. Thus, even if a data signal is provided to the voltage regulation branch 210 in the first phase, it will not affect the initialization of the voltage on the data line Data by the initialization module 100.

In some embodiments, the second switch unit includes a second thin-film transistor. The second thin-film transistor operates in the linear region when conductive. In one embodiment, the second switch unit, acting as a switch, has a fast switching speed, ensuring rapid switching between the first phase and the second phase, and preventing display abnormalities caused by the data voltage on the data line Data not corresponding to the display grayscale after the second phase due to the inability to stably maintain the initialization voltage V0 on the data line Data from slow switching between the first phase and the second phase. In other embodiments, the second switch unit includes a transmission gate circuit or a metal-oxide-semiconductor field-effect transistor, which can also ensure that the second switch unit has a fast switching speed.

In other embodiments, the regulation control unit may not be provided. In this case, in the first phase, a turn-off control signal is provided to each voltage regulation branch 210 to turn off each voltage regulation branch 210; in the second phase, the conductive state of the voltage regulation branch 210 is controlled according to the data signal, thereby controlling the total current for charging or discharging of the voltage regulation module 200.

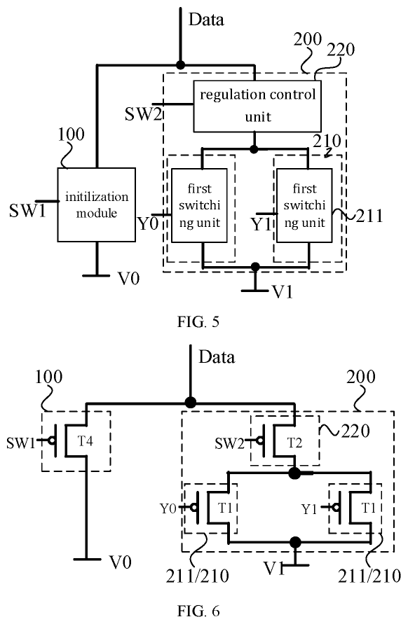

FIG. 6 is a schematic structural diagram of another voltage regulation circuit provided by an embodiment of the present disclosure. Referring to FIG. 6, in an embodiment, the first switch unit 211 includes a first thin-film transistor T1. In an embodiment, the width-to-length ratios of the first thin-film transistors T1 in different voltage regulation branches 210 are different, and the channel materials of the first thin-film transistors T1 in different voltage regulation branches 210 are the same.

As shown in FIG. 6, the voltage regulation branch 210 includes the first thin-film transistor T1 and no other circuit devices. In this case, the first thin-film transistor T1 can function as a resistor. In an embodiment, the first thin-film transistor T1 operates in the saturation region when conductive.

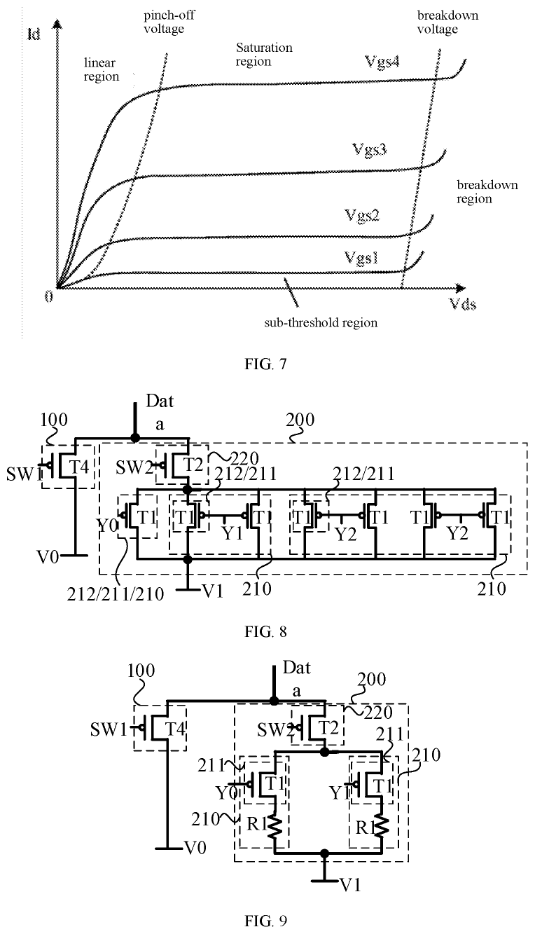

FIG. 7 is a schematic diagram of an output characteristic curve of a transistor provided by an embodiment of the present disclosure. Referring to FIG. 7, the horizontal axis represents the drain-source voltage Vds of the transistor, and the vertical axis represents the current Id when the transistor is conductive. When the drain-source voltage Vds is low (below the pinch-off voltage), the transistor operates in the linear region; when the drain-source voltage Vds is high (exceeding the breakdown voltage), the transistor operates in the breakdown region; when the drain-source voltage Vds is between the pinch-off voltage and the breakdown voltage and the gate-source voltage Vgs is higher than the threshold voltage, the transistor operates in the saturation region. From |Vgs|<|Vgs2|<|Vgs3|<|Vgs4|, it can be seen that in the saturation region, as the gate-source voltage |Vgs| increases, the conductive current gradually increases.

By setting a small width-to-length ratio of the first thin-film transistor T1, the first thin-film transistor T1 has a large channel resistance, and the current when the first thin-film transistor T1 is conductive is not too large, thereby preventing the charging or discharging speed from being too fast, and thus avoiding the situation where the data voltage on the data line Data is equal to the first fixed voltage under data signals corresponding to each display grayscale, making multi-grayscale display impossible. Since the magnitude of the current flowing through the first thin-film transistor T1 is related to its width-to-length ratio, in this embodiment, the width-to-length ratios of the first thin-film transistors T1 in different voltage regulation branches 210 are different, which can make the charge/discharge currents different when different voltage regulation branches 210 are conductive, thereby achieving different degrees of charging or discharging of the data line Data when different voltage regulation branches 210 are conductive, and thus achieving multi-grayscale display. Here, the conductive materials of the first thin-film transistors T1 in different voltage regulation branches 210 are the same, and the first thin-film transistors T1 in different voltage regulation branches 210 can be fabricated using the same process.

In an embodiment, the carrier mobility of the first thin-film transistors T1 in the voltage regulation branches 210 are the same, and the gate oxide capacitance (capacitance per unit area of the gate oxide) is also the same. Thus, when the first thin-film transistor T1 is conductive, the charge/discharge current is determined by the channel width-to-length ratio.

In an embodiment, the effective level voltages for controlling the conduction of each first thin-film transistor T1 corresponding to the data signal are the same.

The effective level voltage is a voltage that turns on the first thin film transistor T1.

The effective level voltages controlling the conduction of each first thin film transistor T1 are the same, i.e., the voltages controlling the conduction of each first thin film transistor T1 are identical, such that the gate voltages of the first thin film transistors T1 are the same, when the first thin film transistors T1 are turned on, and the sources of the first thin film transistors T1 are interconnected, thus the gate-source voltage differences of each first thin film transistor T1 are identical. The on-current of the first thin film transistor T1 is determined by its own width-to-length ratio. By setting a ratio of the width-to-length ratio of the first thin film transistor T1 in the i-th voltage regulation branch 210, to the width-to-length ratio of the first thin film transistor T1 in the first voltage regulation branch 210, to be 2ⁱ⁻¹, to make the charging/discharging current when the i-th voltage regulation branch 210 is turned on be twice that when the (i−1)-th voltage regulation branch 210 is turned on.

Since the durations of the effective level voltage controlling the conductions of the first thin film transistor T1 corresponding to the data signals are the same, under the condition that the width-to-length ratios of the first thin film transistors T1 in different voltage regulation branches 210 are different, within the same conduction time, the total voltage for charging or discharging the data line Data by different voltage regulation branches 210 is different, thereby achieving the adjustment of the voltage of the data line Data from an initialization voltage to different voltages by controlling the conduction of different voltage regulation branches 210.

In some embodiments, the first thin film transistor T1 is an N-type transistor. In this case, the source of the first thin film transistor T1 is connected to a first fixed voltage, and that the source voltage of the first thin film transistor T1 does not change with the charging or discharging of the data line Data, to ensure that in the second phase, the data line Data is charged or discharged with a constant current, causing the voltage on the data line Data to change uniformly over time, and after the second phase ends, the data voltage on the data line Data matches the display grayscale, thus ensuring a good display effect.

In an embodiment, in the voltage regulation module 200, a ratio of the width-to-length ratio of the first thin film transistor T1 in the i-th voltage regulation branch 210, to the width-to-length ratio of the first thin film transistor T1 in the first voltage regulation branch 210, is 2ⁱ⁻¹. Wherein, i is a positive integer greater than or equal to 2 and less than or equal to n, and n is the total number of voltage regulation branches 210 included in the voltage regulation module 200, with n≥2. Wherein, the width-to-length ratio of the first thin film transistor T1 refers to the width-to-length ratio of the semiconductor channel of the first thin film transistor T1.

By setting a ratio of the width-to-length ratio of the first thin film transistor T1 in the i-th voltage regulation branch 210, to the width-to-length ratio of the first thin film transistor T1 in the first voltage regulation branch 210, to be 2ⁱ⁻¹, to make the equivalent resistance when the i-th voltage regulation branch 210 is turned on be ½ of the equivalent resistance when the (i−1)-th voltage regulation branch 210 is turned on. Correspondingly, the charging/discharging current, when the i-th voltage regulation branch 210 is turned on, is twice that when the (i−1)-th voltage regulation branch 210 is turned on.

Within the same conduction time, the total voltage for charging or discharging the data line Data by the k-th voltage regulation branch 210 is twice the total voltage for charging or discharging the data line Data by the (k−1)-th voltage regulation branch 210, thereby achieving that the data line is charged or discharged to a data voltage corresponding to the display grayscale.

Thus, on one hand, different voltage regulation branches 210 have different corresponding charging/discharging currents when they are turned on, resulting in different data voltages to which the data line Data is discharged under different data signals, thereby achieving multi-grayscale display. On the other hand, when the voltage regulation branches 210 are turned on, under the current relationship of different voltage regulation branches 210, the obtained data voltage matches the display grayscale corresponding to the data signal, ensuring that the brightness corresponding to the grayscale can approach or reach the target brightness. Additionally, this embodiment requires a small number of first thin film transistors T1 and a small number of signal lines, which is beneficial for space compression, thereby achieving a display device with a narrow bezel.

In an embodiment, the data signal includes a digital signal of at least two digital bits, the total number of voltage regulation branches 210 included in the voltage regulation module 200 is equal to the total number of digital bits of the data signal, each voltage regulation branch 210 is used to be turned on or off according to a voltage signal corresponding to a digital bit of the data signal, and different voltage regulation branches 210 correspond to different digital bits of the data signal. In this embodiment, the voltage regulation branch 210 includes a first thin film transistor T1, and the total number of first thin film transistors T1 can be equal to the total number of digital bits of the data signal. For example, if the data signal is 2-bit, there are two first thin film transistors T1 connected in parallel; if the display image data is 3-bit, there are three first thin film transistors T1 connected in parallel; if the display image data is k-bit, there are k first thin film transistors T1 connected in parallel, where k is an integer greater than or equal to 2.

FIG. 6 shows a case where two first thin film transistors T1 are connected in parallel, corresponding to a data signal of 2-bit. In an embodiment, the control signal of one first thin film transistor T1 is obtained by converting the data signal of the first digital bit in the data signal, and the control signal of the other first thin film transistor T1 is obtained by converting the data signal of the second digital bit in the data signal.

Table 1 shows an example where the data signal is a 2-bit digital signal, and the data signal D[1:0] has four possible cases as listed in Table 1. Taking the first thin-film transistor T1 as a P-type transistor, and in the pixel circuit connected to the data line Data, where the driving module includes a P-type transistor as an example, the initialization voltage V0 is greater than the first fixed voltage. When the data signal D[1:0] is 00, the control signal Y[1:0] is HH (where H represents a high level and L represents a low level), i.e., Y0=H, Y1=H, then both first thin-film transistors T1 in FIG. 6 are turned off in the second phase. After the second phase, the data voltage on the data line Data equals the initialization voltage V0, corresponding to a display grayscale of 0 grayscale, and the display image is a black image. When the data signal D[1:0] is 01, the control signal Y[1:0] is HL, i.e., Y0=L, Y1=H, then the first one of the first thin-film transistors T1 in FIG. 6 is turned on in the second phase, and the second one of the first thin-film transistors T1 is turned off in the second phase. The voltage adjustment module 200 discharges with a first discharge current I1. After the second phase, the data voltage on the data line Data equals the first data voltage VG1, corresponding to a display grayscale of 1 grayscale, and the display image is a slightly bright image. When the data signal D[1:0] is 10, the control signal Y[1:0] is LH, i.e., Y0=H, Y1=L, then the first one of the first thin-film transistors T1 in FIG. 6 is turned off in the second phase, and the second one of the first thin-film transistors T1 is turned on in the second phase. The voltage adjustment module 200 discharges with a second discharge current I2, where I2=2I1. After the second phase, the data voltage on the data line Data equals the first data voltage VG2. VG2<VG1 corresponds to a display grayscale of 2 grayscale, and the display image is a medium bright image. When the data signal D[1:0] is 11, the control signal Y[1:0] is LL, i.e., Y0=L, Y1=L, then both first thin-film transistors T1 in FIG. 6 are turned on in the second phase. The voltage adjustment module 200 discharges with a third discharge current I3, where I3=3I1. After the second phase, the data voltage on the data line Data equals the first data voltage VG3, VG3<VG2 corresponds to a display grayscale of 3 grayscale, and the display image is a brightest image.

TABLE 1

| Data signal | Control signal | | Display | |
|---|---|---|---|---|
| D[1:0] | Y[1:0] | Data voltage | grayscale | Brightness |
| 00 | HH | V0 | 0 | Black image |
| 01 | HL | VG1 | 1 | Slightly bright |
| 10 | LH | VG2 | 2 | Medium bright |
| 11 | LL | VG3 | 3 | Brightest |

FIG. 8 is a schematic structural diagram of another voltage adjustment circuit provided by an embodiment of the present disclosure. Referring to FIG. 8, in an embodiment, at least one voltage adjustment branch 210 includes at least two parallel sub-branches 212, each sub-branch 212 respectively includes a first switch unit 211; different voltage adjustment branches 210 include different numbers of sub-branches 212. In one embodiment, the conduction states of the first switch units 211 in the same voltage adjustment branch 210 are the same. By setting different numbers of sub-branches 212 included in different voltage adjustment branches 210, it is easy to achieve different charging/discharging currents when different voltage adjustment branches 210 are turned on, thereby achieving different degrees of charging or discharging of the data line Data when different voltage adjustment branches 210 are turned on.

In some embodiments, the first switch unit 211 includes a first thin-film transistor T1. The width-to-length ratios of each first thin-film transistor T1 are equal. In one embodiment, it is easy to achieve different current magnitudes in different voltage adjustment branches 210 when the first thin-film transistors T1 of different voltage adjustment branches 210 are turned on. Moreover, the width-to-length ratios of each first thin-film transistor T1 are equal, making the process characteristics of each first thin-film transistor T1 more similar, which is beneficial for achieving more accurate grayscale display.

In an embodiment, the channel materials of each first thin-film transistor T1 are the same, including that each first thin-film transistor T1 is fabricated using the same process. In an embodiment, the carrier mobilities of each first thin-film transistor T1 are the same, and the gate oxide capacitance (capacitance per unit area of the gate oxide) is also the same. In one embodiment, when the first thin-film transistor T1 is turned on, the charging/discharging current is determined by the channel width-to-length ratio. By setting different numbers of sub-branches 212 included in different voltage adjustment branches 210, different charging/discharging currents can be achieved for different voltage adjustment branches 210.

In some embodiments, the ratio of the number of sub-branches 212 included in the i-th voltage adjustment branch 210 to the number of sub-branches 212 included in the first voltage adjustment branch 210 is 2ⁱ⁻¹. Wherein, i is a positive integer greater than or equal to 2 and less than or equal to n, n is the total number of voltage adjustment branches 210 included in the voltage adjustment module 200, and n≥2; wherein, in the same voltage adjustment branch 210, the sub-branches 212 are simultaneously turned on and simultaneously turned off. In this way, the charging/discharging current when the i-th voltage adjustment branch 210 is turned on is twice the charging/discharging current when the (i−1)-th voltage adjustment branch 210 is turned on.

In one embodiment, on one hand, different charging/discharging currents can be achieved when different voltage adjustment branches 210 are turned on, thereby achieving different data voltages to which the data line Data is discharged under different data signals, thus realizing multi-grayscale display. On the other hand, under the current relationship when different voltage adjustment branches 210 are turned on, the obtained data voltage matches the display grayscale corresponding to the data signal, thereby ensuring that the brightness corresponding to the grayscale can approach or reach the target brightness.

In an embodiment, for the voltage adjustment circuit shown in FIG. 7, the data signal includes a digital signal with at least two digital bits, the total number of voltage adjustment branches 210 included in the voltage adjustment module 200 is equal to the total number of digital bits of the data signal, and each first switch unit 211 in the voltage adjustment branch 210 is used to be turned on or off according to the voltage signal corresponding to the same digital bit of the digital signal, different first switch units 211 correspond to digital signals of different digital bits, thereby achieving that in the same voltage adjustment branch 210, the sub-branches 212 are simultaneously turned on and simultaneously turned off.

In an embodiment, the number of sub-branches 212 included in the first voltage adjustment branch 210 is equal to 1. In one embodiment, under the structure where the current of the voltage adjustment branch 210 is controlled by setting different numbers of sub-branches 212 included in different voltage adjustment branches 210, the number of first thin film transistors T1 included in the voltage adjustment circuit will not be excessive, thereby reducing the area of the voltage adjustment circuit and saving the occupied space of the voltage adjustment circuit. In an embodiment, the first thin film transistor T1 is an N-type transistor.

In an embodiment, the first thin film transistor T1 operates in the saturation region when it is turned on. In some embodiments, the effective level voltages controlling the turning on of each first thin film transistor T1 corresponding to the data signal are the same.

In some embodiments, the width-to-length ratio of each first thin film transistor T1 is less than the width-to-length ratio of the second thin film transistor T2. That is, the width-to-length ratio of each first thin film transistor T1 is less than the width-to-length ratio of the second thin film transistor T2; the channel materials of the first thin film transistor T1 and the second thin film transistor T2 are the same. With such configuration, on one hand, the width-to-length ratio of the first thin film transistor T1 is ensured to be relatively small, reducing the charging/discharging speed of the first thin film transistor T1. On the other hand, the width-to-length ratio of the second thin film transistor T2 is ensured to be relatively large, allowing the second thin film transistor T2 to have a faster switching speed.

FIG. 9 is a schematic structural diagram of another voltage adjustment circuit provided by an embodiment of the present disclosure. Referring to FIG. 9, in an embodiment, the voltage adjustment branch 210 further includes a resistor R1, the resistor R1 is connected in series with the first switch unit 211, and the resistance values of the resistors R1 in different voltage adjustment branches 210 are different.

In an embodiment, unlike the first switch unit 211 in FIG. 6 and FIG. 8 which serves both as a resistor and a switch, in the voltage adjustment circuit shown in FIG. 9, the first switch unit 211 serves as a switch and has no hindering effect on the current. In an embodiment, the first thin film transistor T1 operates in the linear region when it is turned on. In some embodiments, the width-to-length ratio of the first thin film transistor T1 in the first switch unit 211 is greater than or equal to the width-to-length ratio of the second thin film transistor T2 in the second switch unit. In one embodiment, the channel resistance of the first thin film transistor T1 is ensured to be relatively small, allowing the first thin film transistor T1 to have a faster switching speed. Since the voltage adjustment branches 210 are connected in parallel, by setting different resistance values of the resistors R1 in different voltage adjustment branches 210, the charging/discharging current magnitudes when different voltage adjustment branches 210 are turned on are different. Thus, under different data signals, by controlling the turned-on voltage adjustment branches 210 to be not completely the same, the data line Data is charged or discharged to different degrees, achieving multi-gray scale display.

In other embodiments, the width-to-length ratio of the first thin film transistor T1 may also be less than the width-to-length ratio of the second thin film transistor T2, which is not specifically limited in the embodiment of the present invention. In other embodiments, the first switch unit 211 includes a transmission gate circuit or a metal oxide semiconductor field effect transistor. In an embodiment, the ratio of the resistance value of the resistor R1 in the first voltage adjustment branch 210 to the resistance value of the resistor R1 in the k-th voltage adjustment branch 210 is 2^{k-1}. Wherein, k is a positive integer greater than or equal to 2 and less than or equal to n, n is the total number of voltage adjustment branches 210 included in the voltage adjustment module 200, and n≥2. In this way, the charging/discharging current, when the k-th voltage adjustment branch 210 is turned on, is twice the charging/discharging current when the (k−1)-th voltage adjustment branch 210 is turned on. Within the same turn-on time, the total voltage charged or discharged to the data line Data by the k-th voltage adjustment branch 210 is twice the total voltage charged or discharged to the data line Data by the (k−1)-th voltage adjustment branch 210, thereby achieving that the data line is charged or discharged to the data voltage corresponding to the display gray scale.

In one embodiment, on one hand, when the voltage adjustment branches 210 are turned on, the charging/discharging currents corresponding to different voltage adjustment branches 210 can be made different, and the data voltage to which the data line Data is discharged under different data signals is different, achieving multi-gray scale display. On the other hand, under the current relationship when different voltage adjustment branches 210 are turned on, the obtained data voltage can match the display gray scale corresponding to the data signal, thereby ensuring that the brightness corresponding to the gray scale can approach or reach the target brightness.

In an embodiment, taking the voltage adjustment module 200 including two voltage adjustment branches 210 as an example, the ratio of the resistance value of the resistor R1 in the first voltage adjustment branch 210 to the resistance value of the resistor R1 in the second voltage adjustment branch 210 is 2. When the display gray scale is 0 gray scale, both the first voltage adjustment branch 210 and the second voltage adjustment branch 210 are turned off, and no voltage adjustment is performed on the data line Data. Then, after the second stage ends, the voltage on the data line is equal to the initialization voltage V0. When the display gray scale is 1 gray scale, the first voltage adjustment branch 210 is turned on, and the second voltage adjustment branch 210 is turned off. The total charging/discharging current is denoted as I, and the corresponding charging/discharging voltage is denoted as V01, where V01=I×t, t is the duration of the effective level voltage. Then, after the second stage ends, the voltage on the data line is V0-V01 (taking the discharge case as an example). When the display gray scale is 2 gray scale, the first voltage adjustment branch 210 is turned off, and the second voltage adjustment branch 210 is turned on. The total charging/discharging current is 2I, and the corresponding charging/discharging voltage is denoted as V02, where V02=2I×t, t is the duration of the effective level voltage. Then, after the second stage ends, the voltage on the data line is V0-2V01 (taking the discharge case as an example). When the display gray scale is 3 gray scale, the first voltage adjustment branch 210 is turned on, and the second voltage adjustment branch 210 is turned on. The total charging/discharging current is 3I, and the corresponding charging/discharging voltage is denoted as V03, where V03=3I×t, t is the duration of the effective level voltage. Then, after the second stage ends, the voltage on the data line is V0-3V01 (taking the discharge case as an example). In one embodiment, after the second stage ends, the data voltage matches the display gray scale.

In an embodiment, the data signal includes a digital signal of at least two digital bits, and the total number of voltage regulation branches 210 included in the voltage regulation module 200 is equal to the total number of digital bits of the data signal. Each first switch unit 211 is configured to be turned on or off according to a voltage signal corresponding to a digital bit of the data signal, and different first switch units 211 correspond to digital signals of different digital bits.

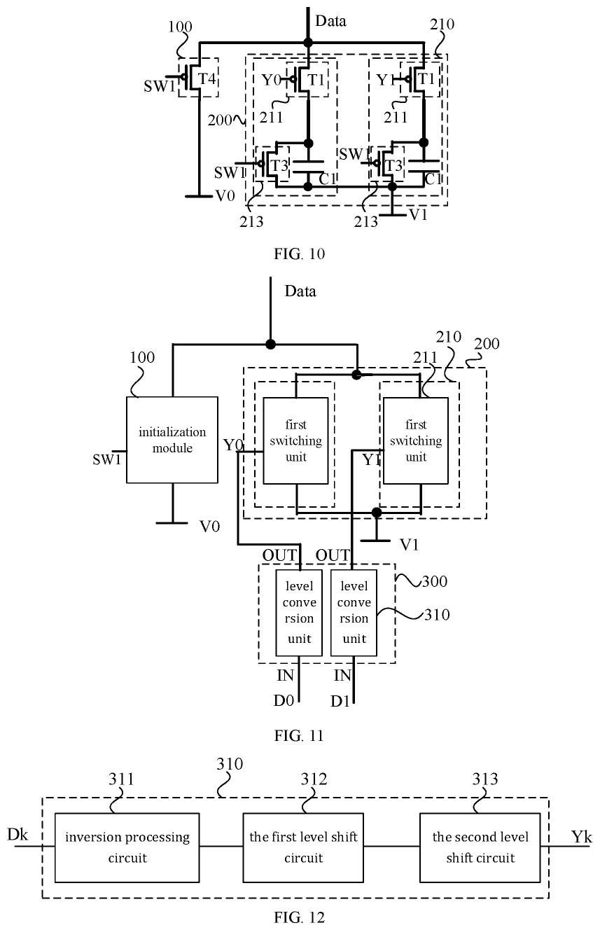

In the voltage regulation circuit structure of this embodiment, the resistance value of the resistor R1 can remain relatively stable over a long period, and the multiple relationship of the charging currents when different voltage regulation branches 210 are turned on can be relatively stable, thereby causing the data voltage to which the data line Data is charged or discharged to vary little over time under the data signal corresponding to the same display gray scale. Thus, it can be ensured that the data voltage can still correspond to the display gray scale after long-term use of the display device, ensuring that the display device can still achieve the target brightness corresponding to the display gray scale after long-term use, thereby ensuring a good display effect. FIG. 10 is a schematic structural diagram of another voltage regulation circuit provided by an embodiment of the present disclosure.

Referring to FIG. 10, in an embodiment, the voltage regulation branch 210 further includes a capacitor C1 and a third switch unit 213, a first terminal of the capacitor C1 is connected to a second terminal of the first switch unit 211, and a second terminal of the capacitor C1 is connected to a first fixed voltage terminal V1; a first terminal of the first switch unit 211 is connected to the data line Data; a first terminal of the third switch unit 213 is connected to the first terminal of the capacitor C1, and a second terminal of the third switch unit 213 is connected to the second terminal of the capacitor C1; the third switch unit 213 is configured to be turned on in a first phase and turned off in a second phase; in different voltage regulation branches 210, the capacitance values of the capacitors C1 are different.

In an embodiment, unlike the first switch unit 211 in FIGS. 6 and 8 which serves both as a resistor and a switch, in the voltage regulation circuit shown in FIG. 10, the first switch unit 211 serves as a switch without impeding current. In the voltage regulation circuit shown in FIG. 10, the third switch unit 213 also serves as a switch without impeding current. In an embodiment, the third switch unit 213 includes a third thin film transistor T3, and the third thin film transistor T3 operates in a linear region when it is turned on. In an embodiment, the first switch unit 211 includes a first thin film transistor T1, and the first thin film transistor T1 operates in a linear region when it is turned on. In other embodiments, the first switch unit 211 includes a transmission gate circuit or a metal oxide semiconductor field effect transistor.

In other embodiments, the third switch unit 213 includes a transmission gate circuit or a metal oxide semiconductor field effect transistor. Thus, it can be ensured that both the first switch unit 211 and the third switch unit 213 have fast switching speeds. In the case where the first switch unit 211 includes a first thin film transistor T1 and the third switch unit 213 includes a third thin film transistor T3, in an embodiment, the width-to-length ratio of the first thin film transistor T1 is greater than or equal to the width-to-length ratio of the third thin film transistor T3. Thus, the channel resistance of the first thin film transistor T1 is ensured to be small, and the first thin film transistor T1 has a fast switching speed. Since the voltage regulation branches 210 are connected in parallel, by setting different resistance values of the resistors R1 in different voltage regulation branches 210, the magnitudes of the charging/discharging currents when different voltage regulation branches 210 are turned on are different, thereby, under different data signals, by controlling the turned-on voltage regulation branches 210 to be not completely the same, the data line Data is charged or discharged to different degrees, achieving multi-gray scale display. In other embodiments, the width-to-length ratio of the first thin film transistor T1 may also be less than the width-to-length ratio of the third thin film transistor T3, which is not particularly limited in the embodiments of the present disclosure.

Referring to FIG. 10, in the first phase, the initialization module 100 is turned on, and the initialization voltage V0 is transmitted to the data line Data. In the first phase, the third switch unit 213 is turned on, short-circuiting both terminals of the capacitor C1, and the voltages across the capacitor C1 are both at the first fixed voltage. In the second phase, the initialization module 100 and the third switch unit 213 are turned off, and the first switch unit 211 in each voltage regulation branch 210 is turned on or off according to the data signal.

Taking the driving transistor in the pixel circuit as a P-type transistor as an example, when the first switch unit 211 is turned on, the charge on the data line Data is distributed to the corresponding capacitor C1. Since the capacitance values of the capacitors C1 in different voltage regulation branches 210 are different, when the first switch units 211 in different voltage regulation branches 210 are turned on, the speed at which the charge on the data line Data is distributed to the corresponding capacitors C1 is different, and after the second phase, the voltage on the data line Data drops to different voltages. Thus, multi-gray scale display of the display device can be achieved. In an embodiment, the initialization module 100 is turned on in the first phase and turned off in the second phase.

Since the third switch unit 213 and the initialization module 100 have the same conduction state in the first phase and the second phase, the thin film transistor included in the initialization module 100 and the third thin film transistor T3 have the same channel material. In an embodiment, the control terminal of the third switch unit 213 and the control terminal of the initialization module 100 are connected to the same control signal line, such as the first control signal line SW1, and the conduction states of the third switch unit 213 and the initialization module 100 are controlled by the same control signal line. In an embodiment, the third switch unit 213 and the initialization module 100 include thin film transistors of the same conduction type, reducing the number of signal lines connected to the voltage regulation circuit, thereby reducing the area of the region where the voltage regulation circuit is located, achieving a display device with a narrow bezel.

In an embodiment, the ratio of the capacitance value of the capacitor C1 in the k-th voltage regulation branch 210 to the capacitance value of the capacitor C1 in the first voltage regulation branch 210, is 2^{k-1}. Here, k is a positive integer greater than or equal to 2 and less than or equal to n, and n is the total number of voltage regulation branches 210 included in the voltage regulation module 200, with n≥2. Thus, the charging/discharging current when the k-th charging/discharging branch voltage regulation branch 210 is turned on is twice that when the (k−1)-th charging/discharging branch voltage regulation branch 210 is turned on. Within the same conduction time, the total voltage charged to or discharged from the data line Data by the k-th voltage regulation branch 210 is twice that by the (k−1)-th voltage regulation branch 210, thereby enabling the data line to be charged or discharged to a data voltage corresponding to a display grayscale.

This configuration, on one hand, ensures that different voltage regulation branches 210 have different charging/discharging currents when they are turned on, leading to different data voltages to which the data line Data is discharged under different data signals, thus achieving multi-grayscale display. On the other hand, it ensures that under the current relationship when different voltage regulation branches 210 are turned on, the obtained data voltage matches the display grayscale corresponding to the data signal, thereby ensuring that the brightness corresponding to the grayscale can approach or reach the target brightness. In some embodiments, the data signal includes a digital signal of at least two digital bits, and the total number of voltage regulation branches 210 included in the voltage regulation module 200 equals the total number of digital bits of the data signal. Each first switch unit 211 is configured to be turned on or off based on a voltage signal corresponding to a digital bit of the digital signal. Different voltage regulation branches 210 correspond to digital signals of different digital bits.

In the voltage regulation circuit structure of this embodiment, the resistance value of the capacitor C1 can remain relatively stable over a long period, making the multiple relationship of the charging currents when different voltage regulation branches 210 are turned on relatively stable. Consequently, under the same data signal corresponding to a display grayscale, the data voltage to which the data line Data is charged or discharged varies little over time. This ensures that after prolonged use of the display device, the data voltage can still correspond to the display grayscale, guaranteeing that the display device can still achieve the target brightness corresponding to the display grayscale after long-term use, thereby ensuring good display performance.

Referring to FIG. 6, FIGS. 8-10, in an embodiment, the initialization module 100 includes a fourth switch unit, a control terminal of the fourth switch unit is connected to the first control signal line SW1, a first terminal of the fourth switch unit receives the initialization voltage V0, and a second terminal of the fourth switch unit is connected to the signal line (FIGS. 6, 8-10 illustrate the case where the signal line is the data line Data).

In an embodiment, the fourth switch unit includes a fourth thin-film transistor T4; the fourth thin-film transistor T4 operates in the linear region when it is turned on. In one embodiment, the fourth switch unit includes a transmission gate circuit or a metal-oxide-semiconductor field-effect transistor. This ensures that the fourth switch unit has a fast switching speed. FIG. 11 is a schematic structural diagram of another voltage regulation circuit provided by an embodiment of the present disclosure. Referring to FIG. 11, in an embodiment, the voltage regulation circuit further includes a level conversion module 300, the level conversion module 300 includes at least two conversion input terminals IN and at least two conversion output terminals OUT, the conversion input terminals IN receive the data signal, and the conversion output terminals OUT are connected to the control terminals of the first switch units 211; the level conversion module 300 is configured to perform level conversion on the data signal to obtain a first control signal; the first switch unit 211 is configured to be turned on or off based on the first control signal corresponding to the data signal.

In FIG. 11, the level conversion module 300 is illustrated with two conversion input terminals IN and two conversion output terminals OUT, and the voltage regulation module 200 includes two voltage regulation branches 210 as an example. In an embodiment, the conversion input terminals IN correspond one-to-one to the conversion output terminals OUT, and the conversion output terminals OUT correspond one-to-one to the voltage regulation branches 210.

In an embodiment, the data signal includes a digital signal of at least two digital bits, and each conversion input terminal IN and conversion output terminal OUT pair is responsible for converting a digital signal of one digital bit. Referring to FIG. 10, taking the data signal including a digital signal of two digital bits as an example, the two digital bits of the digital signal are the first digital bit signal DO and the second digital bit signal D1, respectively. Through the level conversion function of the level conversion module 300, the first digital bit signal DO and the second digital bit signal D1 are converted into corresponding first control signals Y0 and Y1, respectively, and the first control signals Y0 and Y1 are used to control the turning on or off of the two voltage regulation branches 210, respectively. Here, the level conversion module 300 can convert the level corresponding to the data signal to other levels, thereby ensuring that the obtained first control signal can meet the control requirements for the first switch unit 211.

Referring to FIG. 11, in an embodiment, the data signal includes a digital signal of at least two digital bits. The level conversion module 300 includes at least two level conversion units 310. Each level conversion unit 310 receives a digital signal of one digital bit. The level conversion unit 310 is configured to convert the digital signal of the corresponding digital bit into a corresponding first control signal, where the first control signal has an amplitude different from that of the digital signal. In an embodiment, the input terminals of the level conversion units 310 are electrically connected one-to-one to the conversion input terminals IN, and the output terminals of the level conversion units 310 are electrically connected one-to-one to the conversion output terminals OUT. Each level conversion unit 310 is responsible for the level conversion of a digital signal of one digital bit in the data signal. Taking the level conversion module 300 shown in FIG. 11 as including two level conversion units 310 as an example, one of the level conversion units 310 is used to convert the first digital bit signal DO into the corresponding first control signal Y0 to control the conduction state of the first switch unit 211 in one of the voltage regulation branches 210; the other level conversion unit 310 is used to convert the second digital bit signal D1 into the corresponding first control signal Y1 to control the conduction state of the first switch unit 211 in the other voltage regulation branch 210.

FIG. 12 is a structural schematic diagram of a level shift unit provided in an embodiment of the present disclosure. Referring to FIG. 12, in an embodiment, the level shift unit 310 includes an inversion processing circuit 311, a first level shift circuit 312, and a second level shift circuit 313. An input terminal of the inversion processing circuit 311 receives a digital signal. An output terminal of the inversion processing circuit 311 is connected to a first input terminal of the first level shift circuit 312. A second input terminal of the first level shift circuit 312 receives the digital signal of a corresponding digital bit. A first output terminal of the first level shift circuit 312 is connected to a first input terminal of the second level shift circuit 313. A second output terminal of the first level shift circuit 312 is connected to a second input terminal of the second level shift circuit 313. The inversion processing circuit 311 includes at least one stage inverter, configured to output a corresponding inversion processed signal based on the digital signal. The first level shift circuit 312 is configured to output an inverted second level VCC and a non-inverted third level VGL with an amplitude different from that of the first level VSS, and different from that of the second level VCC, based on the digital signal and a first level VSS in the inversion processed signal.

The second level shift circuit 313 is configured to output the third level VGL or a fourth level VGH based on the second level VCC and the third level VGL. The fourth level VGH is non-inverted relative to the second level VCC and has a different amplitude. Here, the inversion processing circuit 311 is configured to perform at least one inversion process on the received digital signal. The inversion processing circuit 311 includes at least one inverter. In a case where the inversion processing circuit 311 includes at least two inverters, the at least two inverters are cascaded. In a case where the inversion processing circuit 311 includes an odd number of inverters, the inversion processed signal obtained after processing by the inversion processing circuit 311 is inverted relative to the digital signal.

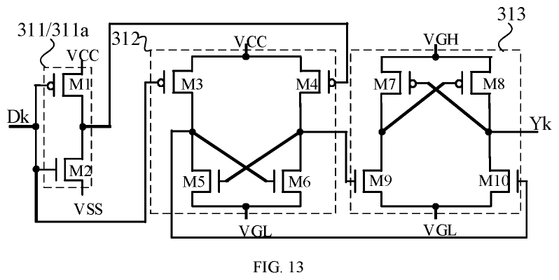

In a case where the inversion processing circuit 311 includes an even number of inverters, the inversion processed signal after processing by the inversion processing circuit 311 is non-inverted relative to the digital signal. FIG. 13 is a specific circuit schematic diagram of a level shift unit 310. Referring to FIG. 13, the inverter 311a includes a first transistor M1 and a second transistor M2. Here, the first transistor M1 is a P-type transistor, and the second transistor M2 is an N-type transistor.

When the k-th bit digital signal Dk is at a high level, the second transistor M2 is turned on, outputting the first level VSS as the inversion processed signal. When the k-th bit digital signal Dk is at a low level, the first transistor M1 is turned on, outputting the second level VCC as the inversion processed signal. The first level shift circuit 312 is respectively connected to the digital signal in the data signal and the output terminal of the inversion processing circuit 311, and can output, based on the digital signal and the first level VSS in the inversion processed signal, a second level VCC inverted relative to the first level VSS and a third level VGL non-inverted relative to the first level VSS and with a different amplitude. Thus, voltage conversion from the first level VSS to the third level VGL can be achieved. Here, the first level VSS and the third level VGL are low levels, and the second level VCC and the fourth level VGH are high levels.

In conjunction with FIG. 11 to FIG. 13, the first level shift circuit 312 includes a third transistor M3, a fourth transistor M4, a fifth transistor M5, and a sixth transistor M6. Here, the third transistor M3 and the fourth transistor M4 are P-type transistors, and the fifth transistor M5 and the sixth transistor M6 are N-type transistors. A gate of the third transistor M3 serves as the second input terminal of the first level shift circuit 312, and a gate of the fourth transistor M4 serves as the first input terminal of the first level shift circuit 312. Here, the gate of the third transistor M3 receives the digital signal, and the gate of the fourth transistor M4 is connected to the output terminal of the inversion processing circuit 311.

Taking the case illustrated in FIG. 13 where the inversion processing circuit 311 includes one inverter as an example, when the digital signal is at a low level, the third transistor M3 is turned on, transmitting the second level VCC to the gate of the sixth transistor M6, thereby turning on the sixth transistor M6. The first level shift circuit 312 outputs the second level VCC to the second level shift circuit 313 via the third transistor M3, and outputs the third level VGL to the second level shift circuit 313 via the sixth transistor M6. When the digital signal is at a high level, the inversion processed signal is at a low level, the fourth transistor M4 is turned on, transmitting the second level VCC to the gate of the fifth transistor M5, thereby turning on the fifth transistor M5. The first level shift circuit 312 outputs the third level VGL to the second level shift circuit 313 via the fifth transistor M5, and outputs the second level VCC to the second level shift circuit 313 via the fourth transistor M4. The second level shift circuit 313 is configured to output the third level VGL or a fourth level VGH based on the second level VCC and the third level VGL, where the fourth level VGH is non-inverted relative to the second level VCC and has a different amplitude, thus enabling voltage conversion from the second level VCC to the fourth level VGH.

In conjunction with FIG. 11 to FIG. 13, in an embodiment, the second level shift circuit 313 includes a seventh transistor M7, an eighth transistor M8, a ninth transistor M9, and a tenth transistor M10. Here, the seventh transistor M7 and the eighth transistor M8 are P-type transistors, and the ninth transistor M9 and the tenth transistor M10 are N-type transistors. A gate of the ninth transistor M9 serves as the first input terminal of the second level shift circuit 313, and a gate of the tenth transistor M10 serves as the second input terminal of the second level shift circuit 313. The gate of the ninth transistor M9 is connected to a common node of the fourth transistor M4 and the sixth transistor M6 in the first level shift circuit 312; the gate of the tenth transistor M10 is connected to a common node of the third transistor M3 and the fifth transistor M5 in the first level shift circuit 312. In the second level shift circuit 313, a common node of the eighth transistor M8 and the tenth transistor M10 serves as an output terminal of the second level shift circuit 313.

When the first level shift circuit 312 outputs the second level VCC to the second level shift circuit 313 via the third transistor M3, and outputs the third level VGL to the second level shift circuit 313 via the sixth transistor M6, the tenth transistor M10 is turned on, the ninth transistor M9 is turned off, and the tenth transistor M10 transmits the third level VGL to the output terminal of the second level shift circuit 313, with the third level VGL serving as the first control signal. When the first level shift circuit 312 outputs the third level VGL to the second level shift circuit 313 via the fifth transistor M5, and outputs the second level VCC to the second level shift circuit 313 via the fourth transistor M4, the ninth transistor M9 is turned on, and the tenth transistor M10 is turned off. The ninth transistor M9 transmits the third level VGL to the gate of the eighth transistor M8, causing the eighth transistor M8 to be turned on, transmitting the fourth level VGH to the output terminal of the second level shift circuit 313, with the fourth level VGH serving as the first control signal. From the above analysis process, it can be seen that when the inversion processing circuit 311 includes one inverter or an odd number of cascaded inverters, the output of the level shift circuit is a voltage that is in phase with the digital signal but has a different amplitude. Correspondingly, when the inversion processing circuit 311 includes an even number of cascaded inverters, the output of the level shift circuit is a voltage that is out of phase with the digital signal and has a different amplitude.

Table 2 shows a case where the voltage regulation module 200 includes eight voltage regulation branches 210, and the data signal D[7:0] is an 8-bit digital data signal, in one embodiment, D0, D1, D2, D3, D4, D5, D6, D7. After level shifting by the level shift module 300, the first control signals Y[7:0] corresponding to the eight voltage regulation branches 210 are Y0, Y1, Y2, Y3, Y4, Y5, Y6, Y7, respectively. When the eight voltage regulation branches 210 are turned on, the charge/discharge currents corresponding to the eight voltage regulation branches 210 are I, 2I, 4I, 8I, 16I, 32I, 64I, and 128I, respectively. By turning on the corresponding voltage regulation branches 210 according to different data signals, display of grayscale levels from 0 to 255 can be achieved. In an embodiment, for the data signal D[7:0] corresponding to grayscale 3, D0=1, D1=1, and the digital signals of other bits are 0, the corresponding charge and discharge current is I+2I=3I. In the second phase, the data line is charged and discharged with a current of 3I. Here, I is the minimum charge and discharge current among the charge and discharge currents corresponding to each voltage regulation branch 210 in the voltage regulation module 200.

TABLE 2

| | | Charge and Discharge |
|---|---|---|
| Data Signal D | First Control Signal Y | Current |
| D7 | Y7 | 128I |
| D6 | Y6 | 64I |
| D5 | Y5 | 32I |
| D4 | Y4 | 16I |
| D3 | Y3 | 8I |
| D2 | Y2 | 4I |
| D1 | Y1 | 2I |
| D0 | Y0 | I |

In an embodiment, the inversion processing circuit 311 includes at least a first inverter. In some embodiments, the inversion processing circuit 311 includes only the first inverter, i.e., the inversion processing circuit 311 includes only one inverter, as shown in FIG. 11. In this case, the first switch unit 211 includes an N-type transistor; the input terminal of the first inverter receives the digital signal of the corresponding bit, and the output terminal of the first inverter is connected to the first input terminal of the first level shift circuit 312. Since the N-type transistor is turned on when the first control signal is at a high level and turned off when it is at a low level, and the digital signal uses a high level “1” to indicate validity and a low level “0” to indicate invalidity, when the first switch unit includes an N-type transistor, the inversion processing circuit 311 includes one inverter, and the output of the level shift circuit is a first control signal that is in phase with the digital signal but has a different amplitude, ensuring that the conduction state of the first switch unit 211 corresponds to the digital signal, thereby achieving accurate grayscale display. In other embodiments, the first switch unit 211 includes a P-type transistor. The inversion processing circuit 311 further includes a second inverter. The input terminal of the second inverter receives the digital signal. The output terminal of the second inverter is connected to the input terminal of the first inverter. The output terminal of the first inverter is connected to the first input terminal of the first level shift circuit 312. Since the P-type transistor is turned off when the first control signal is at a high level and turned on when it is at a low level, and the digital signal uses a high level “1” to indicate validity and a low level “0” to indicate invalidity, when the first switch unit 211 is a P-type transistor, the level shift circuit needs to invert the digital signal.

When the first switch unit includes a P-type transistor, the inversion processing circuit 311 includes two cascaded inverters, i.e., the first inverter and the second inverter, and the output of the level shift circuit is a first control signal that is inverted relative to the digital signal and has a different amplitude, ensuring that the conduction state of the first switch unit 211 corresponds to the digital signal, thereby achieving accurate grayscale display.

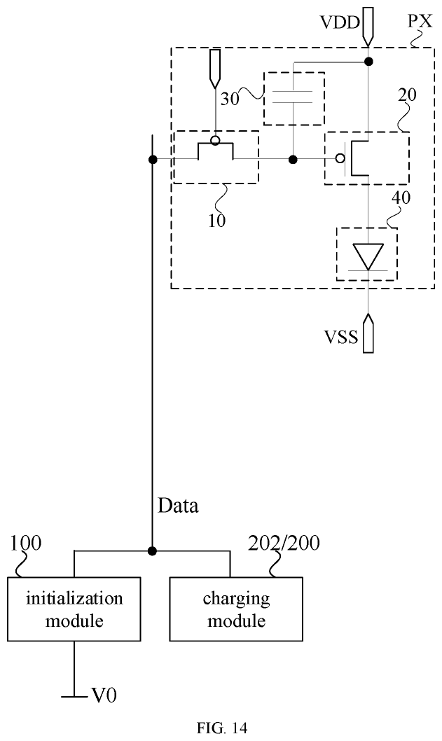

FIG. 14 is a schematic structural diagram of another voltage regulation circuit provided by an embodiment of the present disclosure. FIG. 14 also shows a pixel circuit and a signal line (FIG. 14 shows the case where the signal line is a data line Data). Referring to FIG. 14, in some embodiments of the present disclosure, the pixel circuit connected to the signal line includes a driving module, and the driving module includes a P-type transistor; the voltage regulation module 200 includes a discharge module 201, a first terminal of the discharge module 201 is connected to the signal line, and a second terminal of the discharge module 201 is connected to a first fixed voltage terminal V1; the initialization voltage V0 is greater than the first fixed voltage of the first fixed voltage terminal V1.

In one embodiment, when the driving transistor in the driving module is a P-type transistor, the initialization module 100 can charge the data line Data to an initialization voltage V0 during the first phase. The initialization voltage V0 is a relatively high voltage, and when the gate of the driving transistor is at the initialization voltage V0, the driving transistor is non-conductive. When the driving transistor is a P-type transistor, the voltage regulation module 200 includes a discharge module 201. During the second phase, when the discharge module 201 is turned on, the data line Data discharges to a first fixed voltage terminal V1 through the discharge module 201, causing the voltage on the data line Data to decrease. Under data signals corresponding to different display gray levels, the discharge current of the discharge module 201 varies, resulting in different data voltages on the data line Data after the second phase for different display gray levels.

During the data writing phase of the pixel circuit, the data voltage is written to the gate of the driving transistor, causing the driving transistor to generate a driving current corresponding to the display gray level based on the gate data voltage, thereby achieving image display at different display gray levels. In an embodiment, the initialization voltage V0 is equal to a first reference voltage, and the first reference voltage is greater than or equal to the data voltage corresponding to the minimum gray level within the display gray level range. Here, the data voltages corresponding to the full gray level range from the minimum display gray level to the maximum display gray level are all within a voltage interval having the first reference voltage and a second reference voltage as endpoints. In an embodiment, the second reference voltage is less than or equal to the data voltage corresponding to the maximum gray level within the display gray level range. The first reference voltage and the second reference voltage are inherent voltages in the display panel. By setting the initialization voltage V0 equal to the first reference voltage, there is no need to additionally provide a circuit for supplying the initialization voltage V0 in the display panel, which can reduce the number of devices in the non-display area of the display panel, thereby achieving a narrow bezel. In some embodiments, the first fixed voltage is equal to the second reference voltage or a second power supply voltage on a second power line in the display panel.

With reference to FIGS. 2 and 3, the second power line VSS is connected to the cathode of a light-emitting device in the display panel. When the first fixed voltage is equal to the second reference voltage, it is also conducive to achieving a display device with a narrow bezel. In one embodiment, the display panel needs to be provided with a second power line for transmitting a cathode voltage to the cathode of the light-emitting device. When the first fixed voltage is equal to the second power supply voltage, the first fixed voltage terminal V1 can be connected to the second power line. In one embodiment, there is no need to additionally provide a circuit for supplying the first fixed voltage in the display panel, which can reduce the number of devices in the non-display area of the display panel, achieving a narrow bezel.

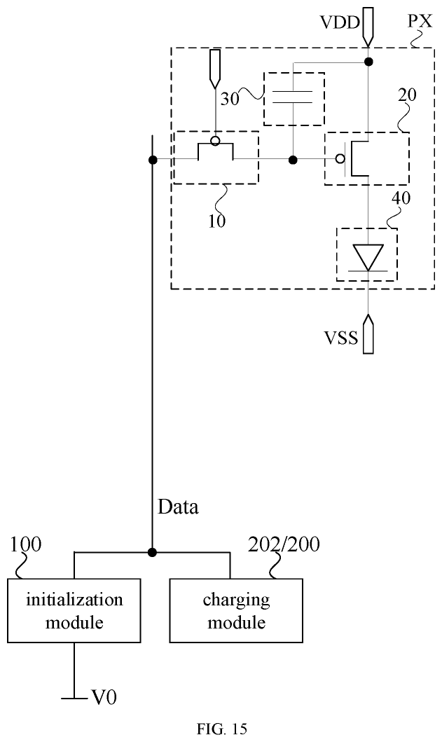

FIG. 15 is a schematic structural diagram of another voltage regulation circuit provided by an embodiment of the present disclosure, where FIG. 15 also shows a pixel circuit and a data line Data. Referring to FIG. 15, in another optional embodiment, the pixel circuit connected to the signal line (FIG. 15 shows the case where the signal line is the data line Data) includes a driving module. The driving module includes an N-type transistor. The voltage regulation module 200 includes a charging module 202. A first end of the charging module 202 is connected to the signal line, and a second end of the charging module 202 is connected to the first fixed voltage terminal V1. The initialization voltage V0 is less than the first fixed voltage at the first fixed voltage terminal V1. When the driving transistor in the driving module is an N-type transistor, the initialization module 100 can charge the data line Data to an initialization voltage V0 during the first phase. The initialization voltage V0 is a relatively low voltage, and when the gate of the driving transistor is at the initialization voltage V0, the driving transistor is non-conductive.

When the driving transistor is an N-type transistor, the voltage regulation module 200 includes a charging module 202. During the second phase, when the charging module 202 is turned on, the first fixed voltage terminal V1 charges the data line Data through the charging module 202, causing the voltage on the data line Data to increase. Under data signals corresponding to different display gray levels, the charging current of the charging module 202 varies, resulting in different data voltages on the data line Data after the second phase for different display gray levels. During the data writing phase of the pixel circuit, the data voltage is written to the gate of the driving transistor, causing the driving transistor to generate a driving current corresponding to the display gray level based on the gate data voltage, thereby achieving image display at different display gray levels.

In an embodiment, the initialization voltage V0 is equal to a second reference voltage, and the second reference voltage is less than or equal to the data voltage corresponding to the minimum gray level within the display gray level range; or, the initialization voltage V0 is equal to a second power supply voltage on a second power line in the display panel. With reference to FIGS. 2 and 3, the second power line VSS is connected to the cathode of the light-emitting device. In an embodiment, the first fixed voltage is equal to a first reference voltage, and the first reference voltage is greater than or equal to the data voltage corresponding to the maximum gray level within the display gray level range; or, with reference to FIGS. 2 and 3, the first fixed voltage is equal to a first power supply voltage on a first power line VDD in the display panel, where the first power line VDD is used to connect to the driving module during the light-emitting phase of the pixel circuit to transmit the first power supply voltage to the driving module. The first power supply voltage is greater than the second power supply voltage.

As described in the above embodiments, the first reference voltage and the second reference voltage are both inherent voltages in the display panel. Setting the second initialization voltage V0 equal to the second reference voltage, and/or setting the first fixed voltage equal to the first reference voltage, is conducive to achieving a narrow bezel. When the initialization voltage V0 is equal to the second power supply voltage on the second power line in the display panel, and/or the first fixed voltage is equal to the first power supply voltage on the first power line in the display panel, it is also conducive to achieving a narrow bezel.

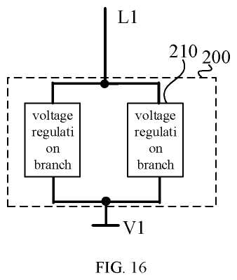

FIG. 16 is a schematic structural diagram of another voltage regulation circuit provided by an embodiment of the present disclosure. Referring to FIG. 16, the voltage regulation circuit includes a voltage regulation module 200, and the voltage regulation module 200 includes at least two voltage regulation branches 210 connected in parallel; one end of the voltage regulation branch 210 is used to connect to the signal line L1, and the other end is connected to the first fixed voltage terminal V1, and the voltage regulation branch 210 is used to regulate the voltage on the signal line L1.

The voltage regulation circuit of an embodiment of the present disclosure regulates the voltage on the signal line L1 through the voltage regulation branch 210 of the voltage regulation module 200. In one embodiment, the voltage on the signal line can be regulated to different levels by controlling the conduction of different voltage regulation branches 210. When the voltage regulation circuit is applied to a display device, the voltage regulation module adjusts the voltage on the data line, and under different display grayscales, the data voltage to which the data line is charged or discharged differs. Thus, under different display grayscales, the data voltage written to the control terminal of the driving module of the pixel circuit differs, resulting in different currents generated by the driving module, thereby achieving different luminance levels of the light-emitting module connected to the pixel circuit, enabling display of different grayscales. Moreover, by including the voltage regulation circuit in the display panel, multi-grayscale display can be achieved without the need for a driving chip, meeting the requirements of space-limited display devices or flexible display devices.

Referring to FIG. 4, in an embodiment, the voltage regulation branch 210 at least includes a first switch unit 211. The voltage regulation branch 210 is connected between the signal line L1 and a first fixed voltage terminal V1. Among them, at least two voltage regulation branches 210 have different conduction currents when they turned on. In an embodiment, each voltage regulation branch 210 is connected in parallel.

Referring to FIGS. 5 and 6, in an embodiment, the voltage regulation module 200 further includes a regulation control unit 220, which is connected between the voltage regulation branch 210 and the signal line L1, and is configured to be turned on during a second phase and turned off during a first phase. In an embodiment, the regulation control unit 220 includes a second switch unit. The second switch unit includes a second thin film transistor T2, which operates in the linear region when it is turned on; in one embodiment, the second switch unit includes a transmission gate circuit or a metal-oxide-semiconductor field-effect transistor. Referring to FIG. 6, the first switch unit 211 includes a first thin film transistor T1.

In an embodiment, the width-to-length ratios of the first thin film transistors T1 in different voltage regulation branches 210 are different. In an embodiment, the channel materials of the first thin film transistors T1 in different voltage regulation branches 210 are the same. In an embodiment, in the voltage regulation module 200, the ratio of the width-to-length ratio of the first thin film transistor T1 in the i-th voltage regulation branch 210 to the width-to-length ratio of the first thin film transistor T1 in the first voltage regulation branch 210 is 2ⁱ⁻¹ where i is a positive integer greater than or equal to 2 and less than or equal to n, and n is the total number of voltage regulation branches 210 included in the voltage regulation module 200, with n≥2.

In an embodiment, the first thin film transistor T1 is an N-type transistor. In an embodiment, the first thin film transistor T1 operates in the saturation region when it is turned on. Referring to FIG. 8, at least one voltage regulation branch 210 includes at least two sub-branches 212 connected in parallel, each sub-branch 212 respectively including a first switch unit 211; different voltage regulation branches 210 include different numbers of sub-branches 212.

In an embodiment, the first switch unit 211 includes a first thin film transistor T1, and the width-to-length ratios of each first thin film transistor T1 are equal. In an embodiment, the channel materials of each first thin film transistor T1 are the same. In an embodiment, the ratio of the number of sub-branches 212 included in the i-th voltage regulation branch 210 to the number of sub-branches 212 included in the first voltage regulation branch 210 is 2ⁱ⁻¹, where i is a positive integer greater than or equal to 2 and less than or equal to n, and n is the total number of voltage regulation branches 210 included in the voltage regulation module 200, with n≥2; wherein, in the same voltage regulation branch 210, the sub-branches 212 are turned on simultaneously and turned off simultaneously. In an embodiment, the first thin film transistor T1 is an N-type transistor.

In an embodiment, the first thin film transistor T1 operates in the saturation region when the first thin film transistor T1 is turned on. In an embodiment, the number of sub-branches 212 included in the first voltage regulation branch 210 is equal to 1. Referring to FIG. 9, the voltage regulation branch 210 further includes a resistor R1, which is connected in series with the first switch unit 211, and the resistance values of the resistors R1 in different voltage regulation branches 210 are different.

In an embodiment, the ratio of the resistance value of the resistor R1 in the first voltage regulation branch 210 to the resistance value of the resistor R1 in the k-th voltage regulation branch 210 is 2^{k-1}, where k is a positive integer greater than or equal to 2 and less than or equal to n, and n is the total number of voltage regulation branches 210 included in the voltage regulation module 200, with n≥2.

In an embodiment, the first switch unit 211 includes a first thin film transistor T1. The first thin film transistor T1 operates in the linear region when it is turned on. In an embodiment, the first switch unit 211 includes a transmission gate circuit or a metal-oxide-semiconductor field-effect transistor.

In an embodiment, the width-to-length ratio of the first thin film transistor T1 in the first switch unit 211 is greater than or equal to the width-to-length ratio of the second thin film transistor T2 in the second switch unit.

Referring to FIG. 10, the voltage regulation branch 210 further includes a capacitor C1 and a third switch unit 213, where a first terminal of the capacitor C1 is connected to a second terminal of the first switch unit 211, and a second terminal of the capacitor C1 is connected to the first fixed voltage terminal V1; a first terminal of the first switch unit 211 is connected to the signal line L1; a first terminal of the third switch unit 213 is connected to the first terminal of the capacitor C1, and a second terminal of the third switch unit 213 is connected to the second terminal of the capacitor C1; the third switch unit 213 is configured to be turned on during a first phase and turned off during a second phase; the capacitance values of the capacitors C1 in different voltage regulation branches 210 are different.

In an embodiment, the ratio of the capacitance value of the capacitor C1 in the k-th voltage regulation branch 210 to the capacitance value of the capacitor C1 in the first voltage regulation branch 210 is 2^{k-1}, where k is a positive integer greater than or equal to 2 and less than or equal to n, and n is the total number of voltage regulation branches 210 included in the voltage regulation module 200, with n≥2. In an embodiment, the third switch unit 213 includes a third thin film transistor T3. The third thin film transistor T3 operates in the linear region when it is turned on. In an embodiment, the third switch unit 213 includes a transmission gate circuit or a metal-oxide-semiconductor field-effect transistor.

In an embodiment, the first switch unit 211 includes a first thin-film transistor T1. The first thin-film transistor T1 operates in the linear region when it is turned on. The first switch unit 211 includes a transmission gate circuit or a metal-oxide-semiconductor field-effect transistor. In an embodiment, the width-to-length ratio of the first thin-film transistor T1 is greater than or equal to the width-to-length ratio of the third thin-film transistor T3.

Referring to FIG. 11, in an embodiment, the voltage regulation circuit further includes a level shift module 300, the level shift module 300 includes at least two conversion input terminals IN and at least two conversion output terminals OUT, the conversion input terminals IN receive data signals, and the conversion output terminals OUT are connected to the control terminal of the first switch unit 211; the level shift module 300 is configured to perform level shifting on the data signal to obtain a first control signal; the first switch unit 211 is configured to be turned on or off based on the first control signal corresponding to the data signal.

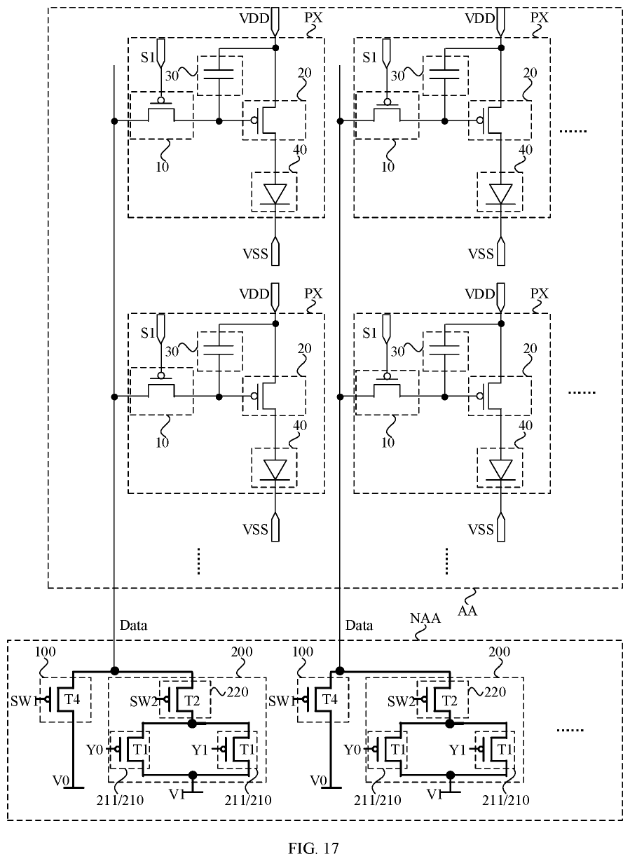

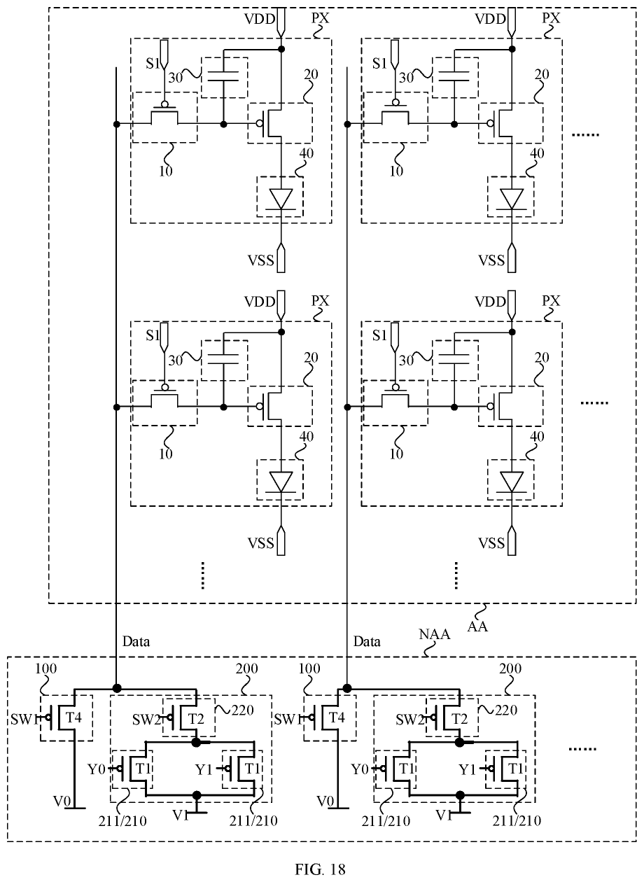

Referring to FIGS. 1, 4-6, and 8-11, the voltage regulation circuit further includes an initialization module 100, the initialization module 100 is configured to connect to a signal line L1, and to transmit an initialization voltage V0 on the signal line L1 during a first phase; the voltage regulation branch 210 is configured to regulate the voltage on the signal line L1 during a second phase, the second phase being performed after the first phase. An embodiment of the present disclosure further provides a display panel. FIG. 17 is a schematic structural diagram of a display panel provided by an embodiment of the present disclosure, and FIG. 18 is a schematic structural diagram of another display panel provided by an embodiment of the present disclosure.

Referring to FIGS. 17 and 18, the display panel includes a plurality of voltage regulation circuits according to any of the above embodiments of the present disclosure, and the signal lines connected to the voltage regulation circuits include data lines. The display panel of the embodiment of the present disclosure has the beneficial effects of the voltage regulation circuit according to any of the above embodiments of the present disclosure, which will not be repeated here.

Continuing to refer to FIGS. 17 and 18, in an embodiment, the display panel further includes a plurality of data lines Data, a plurality of first scan lines S1, and a plurality of pixel circuits PX, the plurality of pixel circuits PX being arranged in an array; the data lines Data are electrically connected correspondingly to the voltage regulation circuits, the data lines Data are also connected to a plurality of pixel circuits PX in at least one column of pixel circuits PX, and the first scan lines S1 are connected to a plurality of pixel circuits PX in at least one row of pixel circuits PX; the pixel circuit PX includes a data writing module 10 and a driving module 20, the data writing module 10 being configured to, under the control of a first scan signal on the first scan line S1, write a corresponding data voltage to the driving module 20 after the corresponding second phase of the voltage regulation circuit.

Among them, FIG. 17 illustrates a case where the driving module 20 in the pixel circuit PX includes a P-type transistor, and the data writing module 10 includes a P-type transistor. FIG. 18 illustrates a case where the driving module 20 in the pixel circuit PX includes an N-type transistor, and the data writing module 10 includes an N-type transistor. As shown in FIGS. 17 and 18, in an embodiment, the voltage regulation circuits are electrically connected one-to-one correspondingly to the data lines Data. In some embodiments, each data line Data is connected to one column of pixel circuits PX, and/or each first scan line S1 is connected to one row of pixel circuits PX. In an embodiment, the display panel includes a display area AA and a non-display area NAA, the voltage regulation circuits are located in the non-display area NAA, and the pixel circuits PX are located in the display area AA.

In an embodiment, the voltage regulation circuits and the pixel circuits PX are fabricated in the same process, the voltage regulation circuits are circuit structures included within the display panel, and the voltage regulation circuits are fabricated in the same process as the pixel circuits PX, without the need to bond a driver chip on the display panel, thereby enabling driving of the pixel circuits PX, achieving multi-grayscale display, realizing a display device with a narrow bezel, and meeting the requirements of display devices with spatial limitations. Furthermore, the bonding process can be reduced, simplifying the fabrication process and improving the fabrication efficiency of the display panel.

In some embodiments, the display panel further includes a substrate, and both the pixel circuits PX and the voltage regulation circuits are located on the substrate; and, both the pixel circuits PX and the voltage regulation circuits can be fabricated on the substrate. The substrate can provide buffering, protection, or support for the display device. The substrate can be a flexible substrate, and, compared to a structure where a driver chip is provided in the display device, the flexibility of the voltage regulation circuit portion is also better, allowing the display device to have better flexibility performance, further meeting the requirements of flexible display devices.

Among them, the material of the flexible substrate can be polyimide (PI), polyethylene naphthalate (PEN), or polyethylene terephthalate (PET), etc., or a mixture of the above materials. The substrate can also be a rigid substrate formed of materials such as glass. An embodiment of the present disclosure further provides a driving method for a display panel, the driving method for the display panel includes: dividing into multiple driving phases, writing data voltages to a plurality of pixel circuits; and, in each driving phase, writing data voltages to a portion of the pixel circuits. Each driving phase includes a first phase, a second phase, and a data writing phase.

Among them, for the display panel structure shown in FIGS. 17 and 18 where each first scan line S1 is connected to one row of pixel circuits PX, and each data line Data is connected to one column of pixel circuits PX, in each driving phase, a corresponding data voltage can be written to one row of pixel circuits PX. FIG. 19 is a flowchart of a driving method for a display panel provided by an embodiment of the present disclosure.

Referring to FIG. 19, in an embodiment, the driving method for the display panel includes the following steps. S101, in a first phase, controlling the initialization module in each voltage regulation circuit to be turned on, to transmit an initialization voltage to the data line.

For the display panel structure shown in FIGS. 17 and 18, where each first scan line S1 is connected to one row of pixel circuits PX, and each data line Data is connected to one column of pixel circuits PX, in each driving phase, during the first phase, the initialization module 100 in each voltage regulation circuit is controlled to be turned on, and the initialization voltage V0 is transmitted to each data line Data. S102, in a second phase, regulating the voltage on the data line by controlling the conduction state of the voltage regulation branch of the voltage regulation module in each voltage regulation circuit. The second phase is performed after the first phase.

Among them, under data signals corresponding to different display gray scales, the total charge/discharge current corresponding to the voltage regulation module is different, and after the second phase, the data voltages on the data lines are different. In each driving phase, during the second phase, by controlling the conduction state of the voltage regulation branch of the voltage regulation module in the voltage regulation circuit, the data line is charged or discharged with the total current corresponding to the data signal, and the voltage on the data line is charged or discharged to the corresponding data voltage after the second phase. Among them, the data signals corresponding to the pixel circuits connected to different voltage regulation modules may correspond to the same display gray scale or different display gray scales, and the data signal corresponding to each pixel circuit is determined by the display image. S103, in the data writing phase, controlling the data writing module of some pixel circuits to be turned on, to write the data voltage to the driving module of some pixel circuits. After the second phase in each driving phase, the data line is charged or discharged to the data voltage corresponding to the display gray scale.

Then, the data writing phase can be entered, and an effective level signal is transmitted to a row of pixel circuits through the first scan line, and the data writing module in the row of pixel circuits is turned on, and the corresponding data voltage is transmitted to the control terminal of the driving module, thereby realizing the writing of the data voltage. The data voltage corresponds to the display gray scale, thereby realizing the display of images with different display gray scales. The driving method of the display panel according to the embodiment of the present disclosure is used to drive the display panel according to any of the above embodiments of the present disclosure, and has the beneficial effects of the display panel according to any of the above embodiments of the present disclosure.

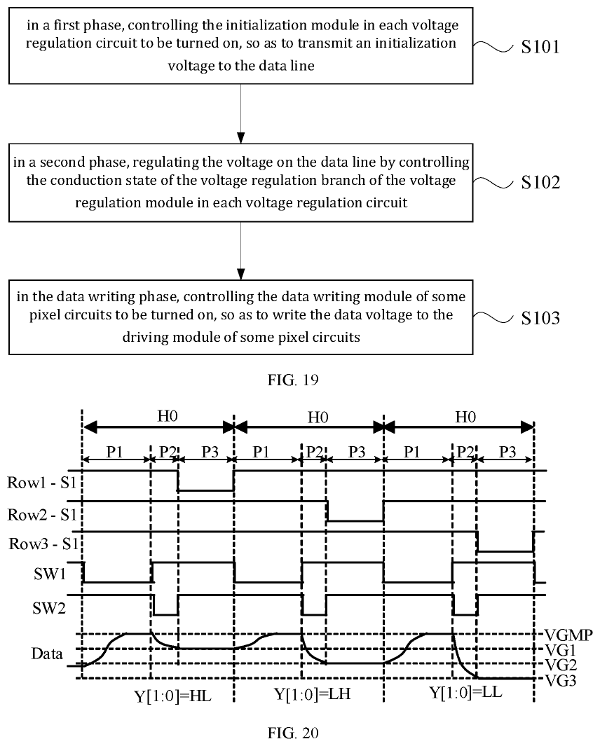

FIG. 20 is a driving timing diagram of a display panel provided by an embodiment of the present disclosure, and the driving timing can be used to drive the display panel shown in FIG. 17. Referring to FIG. 17 and FIG. 20, each driving phase H0 can perform data voltage writing for one row of pixel circuits PX. For the display panel shown in FIG. 17, the first thin film transistor T1 of the first switch unit 211 is a P-type transistor, the second thin film transistor T2 of the second switch unit is a P-type transistor, the fourth thin film transistor T4 of the initialization module 100 is a P-type transistor, and both the data writing module 10 and the driving module 20 include P-type transistors as an example for explanation. In the first phase P1, the signal on the first control signal line SW1 is at a low level, the fourth thin film transistor T4 in each voltage regulation circuit is turned on, and the initialization voltage V0 is transmitted to each data line Data respectively, and the data line Data is charged to a higher voltage. The signal on the second control signal line SW2 is at a high level, and the second thin film transistor T2 is turned off. In the first phase P1, the first scan signal on the first scan line S1 is at a high level, and the data writing module 10 is turned off. In the second phase P2, the signal on the second control signal line SW2 is at a low level, and the second thin film transistor T2 is turned on. The signal on the first control signal line SW1 is at a high level, and the fourth thin film transistor T4 is turned off. When the second thin film transistor T2 is turned on, at least one first thin film transistor T1 can connect the first fixed voltage terminal V1 and the data line Data. For the case where the voltage regulation branch 210 shown in FIG. 17 only includes the first thin film transistor T1, by setting different width-to-length ratios of different voltage regulation branches 210, different discharge currents when different voltage regulation branches 210 are turned on are achieved. Each voltage regulation module 200 in the voltage regulation circuit discharges the data line Data with the total current corresponding to the data signal, and the voltage on the data line Data is discharged to the corresponding data voltage after the second phase P2.

Among them, FIG. 17 shows an example where the voltage regulation module 200 includes two voltage regulation branches 210. The correspondence relationship between the data signal, the first control signal, the data voltage, the display gray scale, and the image brightness can refer to Table 1, which will not be repeated here. In the second phase P2, the first scan signal on the first scan line S1 is at a high level, and the data writing module 10 is turned off. In the data writing phase P3, the first scan signal on the first scan line S1 is at a low level, the data writing module 10 is turned on, and the data voltage is transmitted to the control terminal of the driving module 20, i.e., the gate of the driving transistor.

In the data writing phase P3, the levels on the first control signal line SW1 and the second control signal line SW2 are both at a high level, and the fourth thin film transistor T4 and the second thin film transistor T2 are both turned off. In the light emitting phase, the driving transistor generates a driving current according to the data voltage at the gate and the first power supply voltage. Since the data voltage written to the gate of the driving module 20 corresponds to the display gray scale, under different display gray scales, the driving transistor can generate different driving currents, and the light emitting brightness of the light emitting device corresponds to the display gray scale, thereby realizing the display of images with multiple display gray scales.

Among them, FIG. 20 schematically shows the process of the driving phase corresponding to the pixel circuits of the first row to the third row, and the first driving phase H0 corresponds to the process of data writing for the pixel circuit of the first row, Row-S1 represents the first scan signal corresponding to the first scan line connected to the pixel circuit of the first row; the second driving phase H0 corresponds to the process of data writing for the pixel circuit of the second row, Row-S2 represents the first scan signal corresponding to the first scan line connected to the pixel circuit of the second row; the third driving phase H0 corresponds to the process of data writing for the pixel circuit of the third row, Row-S3 represents the first scan signal corresponding to the first scan line connected to the pixel circuit of the third row. FIG. 20 takes an example where the data signals Y[1:0] corresponding to one voltage regulation circuit in three driving phases are HL, LH, and LL respectively.

It can be seen that in the three driving phases, after the second phase, the data voltages are VG1, VG2, and VG3 respectively, VG1>VG2>VG3, and VGMP represents the first reference voltage. FIG. 17 takes the voltage regulation circuit as the voltage regulation circuit structure shown in FIG. 6 as an example for illustration. When the voltage regulation circuit shown in FIG. 17 is the circuit structure of the voltage regulation circuit shown in FIG. 8 and FIG. 9, the driving timing shown in FIG. 20 is also applicable, which will not be repeated here.

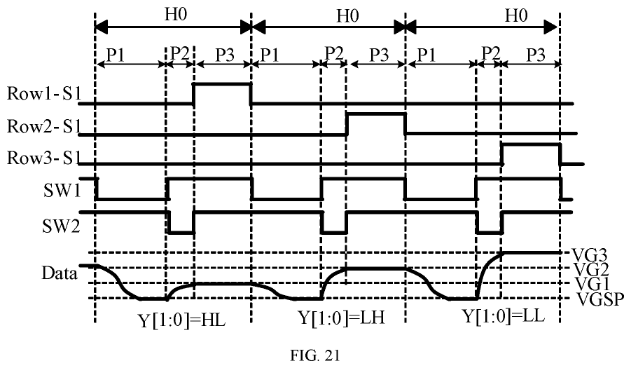

FIG. 21 is a driving timing diagram of another display panel provided by an embodiment of the present disclosure, which can be used to drive the display panel shown in FIG. 18. Referring to FIG. 18 and FIG. 21, each driving stage H0 can perform data voltage writing for one row of pixel circuits PX. For the display panel shown in FIG. 18, a description is given by taking an example where the first thin-film transistor T1 of the first switching unit 211 is a P-type transistor, the second thin-film transistor T2 of the second switching unit is a P-type transistor, the fourth thin-film transistor T4 of the initialization module 100 is a P-type transistor, and both the data writing module 10 and the driving module 20 include N-type transistors. In the first stage P1, the signal on the first control signal line SW1 is at a low level, the fourth thin-film transistor T4 in each voltage regulation circuit is turned on, transmitting the initialization voltage V0 to each data line Data, and the data lines Data are initialized to a lower voltage. The signal on the second control signal line SW2 is at a high level, and the second thin-film transistor T2 is turned off.

In the first stage P1, the first scan signal on the first scan line S1 is at a low level, and the data writing module 10 is turned off. In the second stage P2, the signal on the second control signal line SW2 is at a low level, and the second thin-film transistor T2 is turned on. The signal on the first control signal line SW1 is at a high level, and the fourth thin-film transistor T4 is turned off. When the second thin-film transistor T2 is turned on, at least one first thin-film transistor T1 can connect the first fixed voltage terminal V1 and the data line Data. For the case where the voltage regulation branch 210 shown in FIG. 18 includes only the first thin-film transistor T1, by setting different width-to-length ratios of different voltage regulation branches 210, different discharge currents are achieved when different voltage regulation branches 210 are turned on. Each voltage regulation module 200 in the voltage regulation circuit charges the data line Data with a total current corresponding to the data signal, and the voltage on the data line Data is charged to a corresponding data voltage after the second stage P2.

FIG. 18 illustrates an example where the voltage regulation module 200 includes two voltage regulation branches 210. The correspondence between the data signal, the first control signal, the data voltage, the display grayscale, and the screen brightness can be referred to Table 1, and will not be repeated here. In the second stage P2, the first scan signal on the first scan line S1 is at a low level, and the data writing module 10 is turned off. In the data writing stage P3, the first scan signal on the first scan line S1 is at a high level, the data writing module 10 is turned on, transmitting the data voltage to the control terminal of the driving module 20, i.e., the gate of the driving transistor. In the data writing stage P3, the levels on the first control signal line SW1 and the second control signal line SW2 are both at a low level, and the fourth thin-film transistor T4 and the second thin-film transistor T2 are both turned off. In the light-emitting stage, the driving transistor generates a driving current based on the data voltage at the gate and the first power supply voltage. Since the data voltage written to the gate of the driving module 20 corresponds to the display grayscale, under different display grayscales, the driving transistor can generate different driving currents, and the light-emitting brightness of the light-emitting device corresponds to the display grayscale, enabling screen display with multiple display grayscales.

FIG. 21 schematically shows the process of driving stages corresponding to pixel circuits in the first to third rows, where the first driving stage H0 corresponds to the data writing process for the pixel circuit in the first row, Row-S1 represents the first scan signal corresponding to the first scan line connected to the pixel circuit in the first row; the second driving stage H0 corresponds to the data writing process for the pixel circuit in the second row, Row-S2 represents the first scan signal corresponding to the first scan line connected to the pixel circuit in the second row; the third driving stage H0 corresponds to the data writing process for the pixel circuit in the third row, Row-S3 represents the first scan signal corresponding to the first scan line connected to the pixel circuit in the third row.

FIG. 21 takes an example where a voltage regulation circuit has data signals Y[1:0] corresponding to three driving stages as HL, LH, and LL, respectively. It can be seen that in the three driving stages, after the second stage, the data voltages are VG3, VG2, and VG1, respectively, with VG1>VG2>VG3, and VGSP represents the second reference voltage.

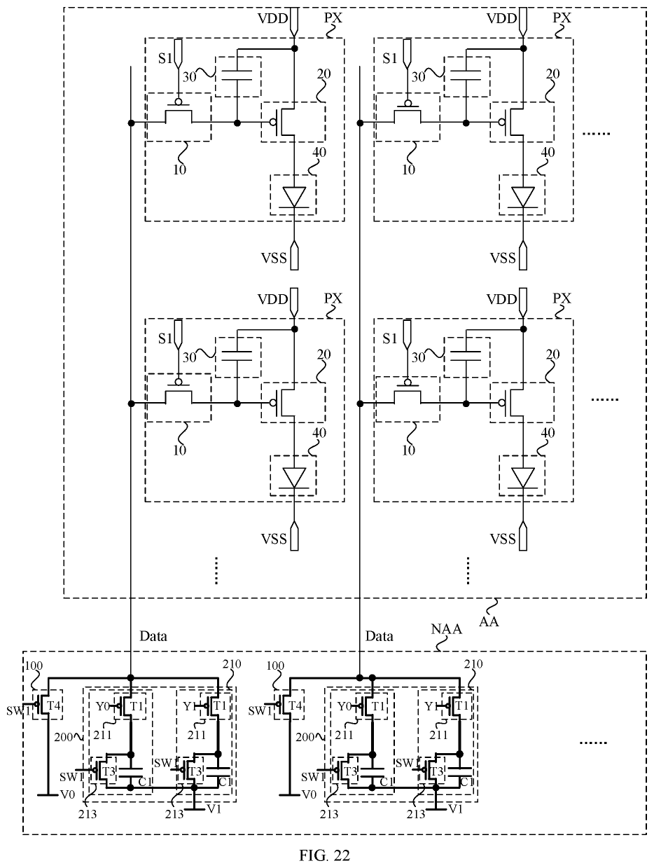

FIG. 21 illustrates an example where the voltage regulation circuit has the structure of the voltage regulation circuit shown in FIG. 6. When the voltage regulation circuit shown in FIG. 21 has the circuit structure of the voltage regulation circuit shown in FIG. 8 and FIG. 9, the driving timing shown in FIG. 21 is also applicable, and will not be repeated here. FIG. 22 is a schematic structural diagram of yet another display panel provided by an embodiment of the present disclosure.

FIG. 23 is a driving timing diagram of yet another display panel provided by an embodiment of the present disclosure, which can be used to drive a display panel including the voltage regulation circuit shown in FIG. 22. Referring to FIG. 22 and FIG. 23, and also referring to

FIG. 17 and FIG. 20, each driving stage H0 can perform data voltage writing for one row of pixel circuits PX. For the display panel shown in FIG. 17, a description is given by taking an example where the first thin-film transistor T1 of the first switching unit 211 is a P-type transistor, the second thin-film transistor T2 of the second switching unit is a P-type transistor, the fourth thin-film transistor T4 of the initialization module 100 is a P-type transistor, and both the data writing module 10 and the driving module 20 include P-type transistors. In the first stage P1, the signal on the first control signal line SW1 is at a low level, the fourth thin-film transistor T4 in each voltage regulation circuit is turned on, transmitting the initialization voltage V0 to each data line Data, and the data lines Data are charged to a higher voltage. The third thin-film transistor T3 is turned on, short-circuiting both ends of the capacitor C1. In the first stage P1, the first scan signal on the first scan line S1 is at a high level, and the data writing module 10 is turned off.

In the second phase P2, the signal on the first control signal line SW1 is at a high level, and the third thin-film transistor T3 and the fourth thin-film transistor T4 are turned off. Each voltage regulation module 200 in the voltage regulation circuit controls the conduction state of the first switching unit 211 in each voltage regulation branch 210 according to the data signal. The correspondence relationship among the data signal, the first control signal, the data voltage, the display grayscale, and the screen brightness can be referred to Table 1, which will not be repeated here. In the second phase P2, the first scan signal on the first scan line S1 is at a high level, and the data writing module 10 is turned off. In the data writing phase P3, the first scan signal on the first scan line S1 is at a low level, the data writing module 10 is turned on, and the data voltage is transmitted to the control terminal of the driving module 20, i.e., the gate of the driving transistor. In the data writing phase P3, the levels on the first control signal line SW1 and the second control signal line SW2 are both at a high level, and the fourth thin-film transistor T4 and the second thin-film transistor T2 are both turned off. In the light-emitting phase, the driving transistor generates a driving current based on the data voltage at the gate and the first power supply voltage. Since the data voltage written to the gate of the driving module 20 corresponds to the display grayscale, under different display grayscales, the driving transistor can generate different driving currents, causing the light-emitting brightness of the light-emitting device to correspond to the display grayscale, thereby enabling screen display of multiple display grayscales.

FIG. 23 schematically illustrates the process of the driving phases corresponding to the pixel circuits in the first to third rows, where the first driving phase H0 corresponds to the data writing process of the pixel circuit in the first row, Row-S1 represents the first scan signal corresponding to the first scan line connected to the pixel circuit in the first row; the second driving phase H0 corresponds to the data writing process of the pixel circuit in the second row, Row-S2 represents the first scan signal corresponding to the first scan line connected to the pixel circuit in the second row; the third driving phase H0 corresponds to the data writing process of the pixel circuit in the third row, Row-S3 represents the first scan signal corresponding to the first scan line connected to the pixel circuit in the third row.

FIG. 23 takes an example where a voltage regulation circuit has data signals Y[1:0] corresponding to HL, LH, and LL in three driving phases, respectively. It can be seen that in the three driving phases, after the second phase, the data voltages are VG1, VG2, and VG3, respectively, with VG1>VG2>VG3, and VGMP represents the first reference voltage.

As shown in FIGS. 17, 18, and 22, in an embodiment, the voltage regulation module 200 includes at least two voltage regulation branches 210 connected in parallel, each voltage regulation branch 210 at least includes a first switching unit 211, and the voltage regulation branch 210 is connected between the data line Data and the first fixed voltage terminal V1; in the above embodiment, S102 includes: in the second phase P2, controlling the conduction state of the first switching unit 211 of the corresponding voltage regulation branch 210 in the voltage regulation module 200 according to the digital signal of the digital bit of the data signal, to control, when different voltage regulation branches 210 are turned on, the different voltage regulation branches 210 to perform voltage regulation with different magnitudes of conduction current. In one embodiment, the voltage regulation branches 210 can correspond one-to-one to the digital bits of the data signal. In the data signal, the digital signal of each digital bit controls the conduction state of one voltage regulation branch 210, thereby achieving that under data signals corresponding to different display grayscales, the voltage regulation branches 210 that are turned on in the voltage regulation module 200 are not completely identical, thus achieving that under data signals corresponding to different display grayscales, the total current for charging or discharging the data line Data by the voltage regulation module 200 is different, causing the data line Data to be charged or discharged to different data voltages, thereby enabling screen display of multiple display grayscales.

In an embodiment, taking the case where the voltage regulation module 200 in FIGS. 15 and 16 includes two voltage regulation branches 210 as an example, the data signal includes a data signal of 2 digital bits. When the data signal is 00, both voltage regulation branches 210 are not turned on, achieving screen display of 0 grayscale. When the data signal is 01, the voltage regulation branch 210 with a lower charging/discharging current is turned on, and the voltage regulation branch 210 with a higher charging/discharging current is not turned on, achieving screen display of 1 grayscale. When the data signal is 10, the voltage regulation branch 210 with a lower charging/discharging current is not turned on, and the voltage regulation branch 210 with a higher charging/discharging current is turned on, achieving screen display of 2 grayscale. When the data signal is 11, both the voltage regulation branch 210 with a lower charging/discharging current and the voltage regulation branch 210 with a higher charging/discharging current are turned on, achieving screen display of 3 grayscale.

The above description takes the voltage regulation module including a regulation control unit as an example. In other optional embodiments of the present disclosure, the voltage regulation module includes only at least two voltage regulation branches and does not include a regulation control unit. In this case, in the first phase, each voltage regulation branch can be controlled to be turned off, in the second phase, the conduction state of each voltage regulation branch is controlled according to the data signal. In an embodiment, a selection circuit can be used to select the control signal provided to the voltage regulation branches in the first phase and the second phase. An embodiment of the present disclosure also provides a display device.

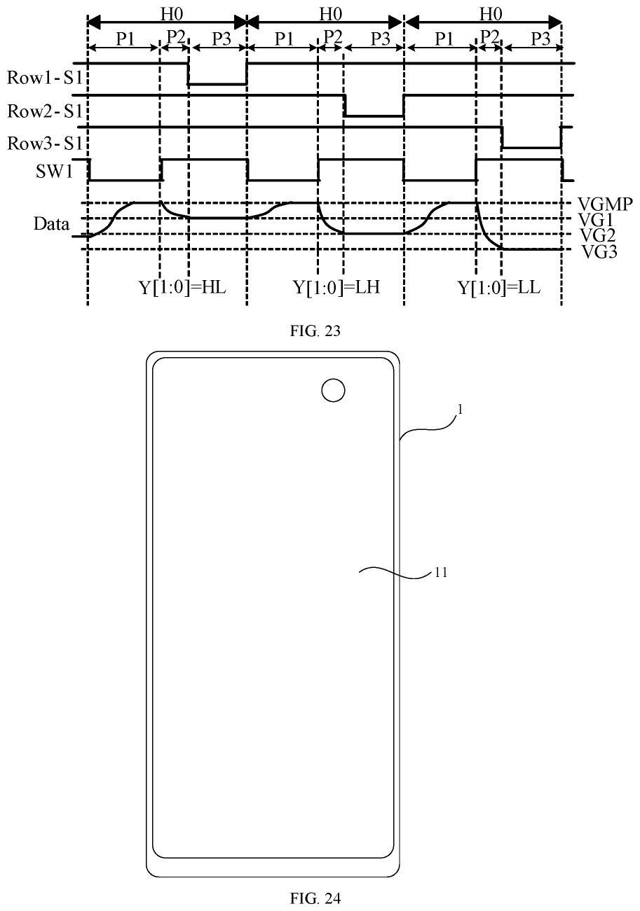

FIG. 24 is a schematic structural diagram of a display device provided by an embodiment of the present disclosure. Referring to FIG. 24, in an embodiment, the display device 1 includes the display panel 11 of any embodiment of the present disclosure. The display device can be a mobile phone, or any electronic product with a display function, including but not limited to the following categories: televisions, notebook computers, desktop monitors, tablet computers, digital cameras, smart bracelets, smart glasses, vehicle-mounted displays, medical equipment, industrial control equipment, touch interaction terminals, and other products.

This embodiment of the present disclosure does not impose special limitations on this. The above specific implementation does not constitute a limitation on the protection scope of the present disclosure. It should be understood that various modifications, combinations, sub-combinations, and substitutions can be made according to design requirements and other factors. Any modifications, equivalent replacements, and improvements made within the spirit and principle of the present disclosure shall be included in the protection scope of the present disclosure.

What is claimed is:

1. A voltage regulation circuit, comprising:
a plurality of signal lines;
an initialization module, configured to be connected to the signal lines and to transmit an initialization voltage to the signal lines in a first phase;
a voltage regulation module, configured to be connected to the signal lines and to regulate the voltage on the signal lines in a second phase;
the second phase is performed after the first phase.

2. The voltage regulation circuit according to claim 1, wherein the voltage regulation module comprises at least two voltage regulation branches connected in parallel, the voltage regulation branches at least comprise a first switch unit, the voltage regulation branches are connected between the signal lines and a first fixed voltage terminal, and are configured to be turned on or off according to a data signal;
wherein, conduction currents of at least two of the voltage regulation branches are different when the voltage regulation branches are turned on.

3. The voltage regulation circuit according to claim 2, wherein the voltage regulation module further comprises a regulation control unit, the regulation control unit is connected between the voltage regulation branches and the signal lines, and is configured to be turned on in the second phase and turned off in the first phase;
the durations of the effective level voltages controlling the voltage regulation branches corresponding to the data signals are the same,
the regulation control unit comprises a second switch unit;
the second switch unit comprises a second thin film transistor, the second thin film transistor operates in a linear region when the second thin film transistor is turned on; or, the second switch unit comprises a transmission gate circuit or a metal oxide semiconductor field effect transistor;
a control terminal of the initialization module is connected to a first control signal line, and a control terminal of the regulation control unit is connected to a second control signal line.

4. The voltage regulation circuit according to claim 2, wherein the first switch unit comprises a first thin film transistor;
width-to-length ratios of the first thin film transistors in different voltage regulation branches are different;
in the voltage regulation module, the ratio of the width-to-length ratio of the first thin film transistor in the i-th voltage regulation branch to the width-to-length ratio of the first thin film transistor in the first voltage regulation branch is 2ⁱ⁻¹, i is a positive integer greater than or equal to 2 and less than or equal to n, n is the total number of voltage regulation branches included in the voltage regulation module, n≥2;
the first thin film transistor operates in a saturation region when the first thin film transistor is turned on;
the effective level voltages controlling the conductions of the first thin film transistors corresponding to the data signals are the same.

5. The voltage regulation circuit according to claim 2, wherein at least one of the voltage regulation branches comprises at least two sub-branches connected in parallel, each of the sub-branches respectively comprises a first switch unit; numbers of the sub-branches in different voltage regulation branches are different;
the first switch unit comprises a plurality of first thin film transistors, and the width-to-length ratios of the first thin film transistors are equal;
the ratio of the number of sub-branches in the i-th voltage regulation branch to the number of sub-branches in the first voltage regulation branch is 2ⁱ⁻¹, i is a positive integer greater than or equal to 2 and less than or equal to n, n is the total number of voltage regulation branches in the voltage regulation module, n≥2;
in the same voltage regulation branch, the sub-branches are turned on simultaneously and turned off simultaneously;
the first thin film transistor operates in a saturation region when the first thin film transistor is turned on;
the effective level voltages controlling the conductions of the first thin film transistors corresponding to the data signals are the same.

6. The voltage regulation circuit according to claim 3, wherein the first switch unit comprises a first thin film transistor, the second switch unit comprises a second thin film transistor, the width-to-length ratio of each first thin film transistor is less than the width-to-length ratio of the second thin film transistor; the channel materials of the first thin film transistor and the second thin film transistor are the same.

7. The voltage regulation circuit according to claim 2, wherein the voltage regulation branch further comprises a resistor, the resistor being connected in series with the first switch unit, and the resistance values of the resistors in different voltage regulation branches are different;
the ratio of the resistance value of the resistor in the first voltage regulation branch to the resistance value of the resistor in the k-th voltage regulation branch is 2^{k-1}, where k is a positive integer greater than or equal to 2 and less than or equal to n, n is the total number of voltage regulation branches in the voltage regulation module, and n≥2;
the first switch unit comprises a first thin film transistor, and the first thin film transistor operates in a linear region when the first thin film transistor is turned on; or,
the first switch unit comprises a transmission gate circuit or a metal oxide semiconductor field effect transistor;
the width-to-length ratio of the first thin film transistor in the first switch unit is greater than or equal to the width-to-length ratio of the second thin film transistor in the second switch unit.

8. The voltage regulation circuit according to claim 2, wherein the voltage regulation branch further comprises a capacitor and a third switch unit, a first end of the capacitor is connected to the second end of the first switch unit, and a second end of the capacitor is connected to the first fixed voltage terminal; a first end of the first switch unit is connected to the signal line; a first end of the third switch unit is connected to the first end of the capacitor, and a second end of the third switch unit is connected to the second end of the capacitor; the third switch unit is configured to be turned on in the first phase and turned off in the second phase; capacitance values of the capacitors in different voltage regulation branches are different;
the ratio of the capacitance value of the capacitor in the k-th voltage regulation branch to the capacitance value of the capacitor in the first voltage regulation branch is 2^{k-1}, where k is a positive integer greater than or equal to 2 and less than or equal to n, n is the total number of voltage regulation branches in the voltage regulation module, and n≥2.

9. The voltage regulation circuit according to claim 8, wherein
the third switch unit comprises a third thin film transistor, and the third thin film transistor operates in a linear region when the third thin film transistor turned on; or, the third switch unit comprises a transmission gate circuit or a metal oxide semiconductor field effect transistor;
the first switch unit comprises a first thin film transistor, and the first thin film transistor operates in a linear region when the first thin film transistor is turned on; or, the first switch unit comprises a transmission gate circuit or a metal oxide semiconductor field effect transistor;
the width-to-length ratio of the first thin film transistor is greater than or equal to the width-to-length ratio of the third thin film transistor;
the initialization module is turned on in the first phase and turned off in the second phase;
the thin film transistor in the initialization module and the third thin film transistor have the same channel material, and the control terminal of the third switch unit and the control terminal of the initialization module are connected to the same control signal line.

10. The voltage regulation circuit according to claim 2, further comprising a level shift module,
the level shift module comprises at least two shift input terminals and at least two shift output terminals, the shift input terminals receiving the data signal, and the shift output terminals being connected to the control terminal of the first switch unit;
the level shift module is configured to perform level shifting on the data signal to obtain a first control signal;
the first switch unit is configured to be turned on or off according to the first control signal corresponding to the data signal;
the data signal comprises a digital signal of at least two digital bits; the level shift module comprises at least two level shift units, each level shift unit receiving the digital signal of one digital bit, and the level shift unit is configured to convert the digital signal of the corresponding digital bit into the corresponding first control signal, the first control signal having an amplitude different from an amplitude of the digital signal.

11. The voltage regulation circuit according to claim 10, wherein the level shift unit comprises an inversion processing circuit, a first level shift circuit, and a second level shift circuit, an input terminal of the inversion processing circuit receives the digital signal, an output terminal of the inversion processing circuit is connected to a first input terminal of the first level shift circuit, a second input terminal of the first level shift circuit receives the digital signal of the corresponding digital bit, a first output terminal of the first level shift circuit is connected to a first input terminal of the second level shift circuit, and a second output terminal of the first level shift circuit is connected to a second input terminal of the second level shift circuit;
the inversion processing circuit comprises an one stage inverter, the one stage inverter is configured to output a corresponding inversion-processed signal according to the digital signal;
the first level shift circuit is configured to output an inverted second level and a non-inverted third level with an amplitude different from that of the first level, based on the digital signal and a first level of the inversion-processed signal;
the second level shift circuit is configured to output the third level or a fourth level, based on the second level and the third level, the fourth level and the second level having a same phase, but a different amplitude;
the inversion processing circuit comprises at least a first inverter;
the first switch unit comprises an N-type transistor; an input terminal of the first inverter receives the digital signal of the corresponding digital bit, and an output terminal of the first inverter is connected to the first input terminal of the first level shift circuit; or,
the first switch unit comprises a P-type transistor, the inversion processing circuit further comprises a second inverter, an input terminal of the second inverter receives the digital signal, an output terminal of the second inverter is connected to an input terminal of the first inverter, and an output terminal of the first inverter is connected to the first input terminal of the first level shift circuit.

12. The voltage regulation circuit according to claim 1, wherein the initialization module comprises a fourth switch unit, a control terminal of the fourth switch unit is connected to a first control signal line, a first terminal of the fourth switch unit receives the initialization voltage, and a second terminal of the fourth switch unit is connected to the signal line; the fourth switch unit comprises a fourth thin film transistor, and the fourth thin film transistor operates in a linear region when the fourth thin film transistor is turned on; or, the fourth switch unit comprises a transmission gate circuit or a metal oxide semiconductor field effect transistor.

13. The voltage regulation circuit according to claim 1, wherein the pixel circuit connected to the signal line comprises a driving module, the driving module comprising a P-type transistor;
the voltage regulation module comprises a discharge module, a first end of the discharge module being connected to the signal line, and a second end of the discharge module being connected to a first fixed voltage terminal;
the initialization voltage is greater than a first fixed voltage of the first fixed voltage terminal;
the initialization voltage is equal to a first reference voltage, the first reference voltage being greater than or equal to a data voltage corresponding to a minimum grayscale within a display grayscale range;
the first fixed voltage is equal to a second reference voltage, the second reference voltage being less than or equal to a data voltage corresponding to a maximum grayscale within the display grayscale range; or, the first fixed voltage is equal to a second power voltage on a second power line in a display panel, wherein the second power line is connected to a cathode of a light-emitting device in the display panel; or,
the pixel circuit connected to the signal line comprises a driving module, the driving module comprising an N-type transistor;
the voltage regulation module comprises a charging module, a first end of the charging module being connected to the signal line, and a second end of the charging module being connected to the first fixed voltage terminal;
the initialization voltage is less than the first fixed voltage of the first fixed voltage terminal; the initialization voltage is equal to the second reference voltage, the second reference voltage being less than or equal to a data voltage corresponding to a minimum grayscale within the display grayscale range; or, the initialization voltage is equal to a second power voltage on a second power line in the display panel, the second power line being connected to the cathode of the light-emitting device;
the first fixed voltage is equal to the first reference voltage, the first reference voltage being greater than or equal to a data voltage corresponding to a maximum grayscale within the display grayscale range; or, the first fixed voltage is equal to a first power voltage on a first power line in the display panel, wherein the first power line is used to connect to the driving module during a light-emitting phase of the pixel circuit to transmit the first power voltage to the driving module; and
the first power voltage is greater than the second power voltage.

14. A voltage regulation circuit, comprising a voltage regulation module,
the voltage regulation module comprises at least two voltage regulation branches connected in parallel;
one end of the voltage regulation branch is connected to a signal line, and the other end is connected to a first fixed voltage terminal, and the voltage regulation branch is used to regulate a voltage on the signal line.

15. The voltage regulation circuit according to claim 14, wherein the voltage regulation branch at least comprises a first switch unit, the voltage regulation branch being connected between the signal line and the first fixed voltage terminal, wherein at least two of the voltage regulation branches have different currents, when the at least two of the voltage regulation branches are turned on;
the voltage regulation branches are connected in parallel;
the voltage regulation module further comprises a regulation control unit, the regulation control unit being connected between the voltage regulation branch and the signal line, and being used to be turned on during a second phase and turned off during a first phase, the second phase being performed after the first phase;
the voltage regulation circuit further comprises an initialization module, the initialization module being used to connect to the signal line and being used to transmit an initialization voltage to the signal line during the first phase;
the voltage regulation branch is used to regulate the voltage on the signal line during the second phase, the second phase being performed after the first phase; preferably, the regulation control unit comprises a second switch unit;
the second switch unit comprises a second thin-film transistor, the second thin-film transistor operating in a linear region when the second thin-film transistor is turned on; or, the second switch unit comprises a transmission gate circuit or a metal-oxide-semiconductor field-effect transistor.

16. The voltage regulation circuit according to claim 15, wherein the first switch unit comprises a first thin film transistor;
the width-to-length ratios of the first thin film transistors in different voltage regulation branches are different;
the channel materials of the first thin film transistors in different voltage regulation branches are the same;
in the voltage regulation module, the ratio of the width-to-length ratio of the first thin film transistor in the i-th voltage regulation branch to the width-to-length ratio of the first thin film transistor in the first voltage regulation branch is 2ⁱ⁻¹, where i is a positive integer greater than or equal to 2 and less than or equal to n, and n is the total number of voltage regulation branches in the voltage regulation module, n≥2;
the first thin film transistor operates in a saturation region when the first thin film transistor is turned on; or, at least one of the voltage regulation branches comprises at least two sub-branches connected in parallel, each of the sub-branches comprising a first switch unit; the numbers of the sub-branches in different voltage regulation branches are different;
the first switch unit comprises a first thin film transistor, and the width-to-length ratios of the first thin film transistors are equal;
the ratio of the number of sub-branches in the i-th voltage regulation branch to the number of sub-branches in the first voltage regulation branch is 2ⁱ⁻¹, where i is a positive integer greater than or equal to 2 and less than or equal to n, and n is the total number of voltage regulation branches in the voltage regulation module, n≥2; in the same voltage regulation branch, the sub-branches are turned on simultaneously and turned off simultaneously;
the first thin film transistor operates in a saturation region when the first thin film transistor is turned on;
the voltage regulation branch further comprises a resistor, the resistor being connected in series with the first switch unit, and the resistance values of the resistors in different voltage regulation branches are different;
the ratio of the resistance value of the resistor in the first voltage regulation branch to the resistance value of the resistor in the k-th voltage regulation branch is 2^{k-1}, where k is a positive integer greater than or equal to 2 and less than or equal to n, and n is the total number of voltage regulation branches in the voltage regulation module, n≥2.

17. The voltage regulation circuit according to claim 15, wherein the voltage regulation branch further comprises a capacitor and a third switch unit,
a first end of the capacitor is connected to a second end of the first switch unit, and a second end of the capacitor is connected to the first fixed voltage terminal;
a first end of the first switch unit is connected to the signal line;
a first end of the third switch unit is connected to the first end of the capacitor, and a second end of the third switch unit is connected to the second end of the capacitor;
the third switch unit is configured to be turned on during the first phase and turned off during the second phase; the capacitance values of the capacitors in different voltage regulation branches are different;
the ratio of the capacitance value of the capacitor in the k-th voltage regulation branch to the capacitance value of the capacitor in the first voltage regulation branch is 2^{k-1}, where k is a positive integer greater than or equal to 2 and less than or equal to n, and n is the total number of voltage regulation branches included in the voltage regulation module, n≥2;
the third switch unit comprises a third thin film transistor, and the third thin film transistor operates in a linear region when the third thin film transistor is turned on; or, the third switch unit comprises a transmission gate circuit or a metal oxide semiconductor field effect transistor;
the first switch unit comprises a first thin film transistor, and the first thin film transistor operates in a linear region when the first thin film transistor is turned on; or, the first switch unit comprises a transmission gate circuit or a metal oxide semiconductor field effect transistor; and
the width-to-length ratio of the first thin film transistor is greater than or equal to the width-to-length ratio of the third thin film transistor.

18. The voltage regulation circuit according to claim 15, further comprising a level shift module, the level shift module comprising at least two conversion input terminals and at least two conversion output terminals, the conversion input terminals inputting data signals, and the conversion output terminals being connected to control terminals of the first switch units;
the level shift module is configured to perform level shifting on the data signals to obtain first control signals; the first switch unit is configured to be turned on or off according to the first control signal corresponding to the data signal.

19. A display panel, comprising: the voltage regulation circuit according to claim 1, wherein the signal line comprises a data line, and the display panel further comprising a plurality of data lines, a plurality of first scan lines, and a plurality of pixel circuits,
the plurality of pixel circuits being arranged in an array;
the data lines are electrically connected to the voltage adjustment circuits correspondingly, the data lines are also connected to a plurality of pixel circuits in at least one column of the pixel circuits, and the first scan lines are connected to a plurality of pixel circuits in at least one row of the pixel circuits;
the pixel circuit comprises a data writing module and a driving module, the data writing module is configured to, under the control of a first scan signal on the first scan line, write a corresponding data voltage to the driving module after a corresponding second phase of the voltage adjustment circuit;
the voltage adjustment circuits are electrically connected to the data lines in a one-to-one correspondence;
each of the data lines is connected to one column of the pixel circuits, each of the first scan lines is connected to one row of the pixel circuits.

20. A driving method for a display panel, wherein, the display panel comprises the voltage adjustment circuit according to claim 1, and the signal lines comprise data lines;
the driving method comprises:
dividing the driving method into a plurality of driving phases to write data voltages to a plurality of pixel circuits;
wherein, in each of the driving phases, writing the data voltage to a portion of the pixel circuits;
each of the driving phases comprises a first phase, a second phase, and a data writing phase; in the first phase, controlling the initialization module in each voltage adjustment circuit to be turned on to transmit an initialization voltage to the data line;
in the second phase, adjusting the voltage on the data line, by controlling the conduction state of the voltage adjustment branch of the voltage adjustment module, in each voltage adjustment circuit; the second phase is performed after the first phase;
in the data writing phase, controlling the data writing module of a portion of the pixel circuits to be turned on to write the data voltage to the driving module of the portion of the pixel circuits.
